(19) United States
(12) Patent Application Publication
(10) Pub. No.: US 2007/0036328 A1
(43) Pub. Date: Feb. 15, 2007

(54) Virtual world escrow

(75) Inventors: Edward K.Y. Jung, Bellevue, WA (US); Royce A. Levien, Lexington, MA (US); Robert W. Lord, Seattle, WA (US); Mark A. Malamud, Seattle, WA (US); John D. Rinaldo JR., Bellevue, WA (US)

Correspondence Address: SEARETE LLC;CLARENCE T. TEGREENE, 1756 - 114TH AVE., S.E., SUITE 110, BELLEVUE, WA, 98004, US

(73) Assignee: Searete LLC

(21) Appl. No.: 11/185,524

(22) Filed: Jul. 19, 2005

(51) Int. Cl. H04M 3/00

(52) U.S. Cl. 379/265.01

(57) ABSTRACT

In one aspect, a method related to conducting virtual world transactions. In addition to the foregoing, other method and system and program product aspects are described in the claims, drawings, and text forming a part of the present application.

### CROSS-REFERENCE TO RELATED APPLICATIONS

The present application is related to, claims the earliest available effective filing date(s) from (e.g., claims earliest available priority dates for other than provisional patent applications; claims benefits under 35 USC § 119(e) for provisional patent applications), and incorporates by reference in its entirety all subject matter of the following listed application(s) (the “Related Applications”) to the extent such subject matter is not inconsistent herewith; the present application also claims the earliest available effective filing date(s) from, and also incorporates by reference in its entirety all subject matter of any and all parent, grandparent, great-grandparent, etc. applications of the Related Application(s) to the extent such subject matter is not inconsistent herewith. The United States Patent Office (USPTO) has published a notice to the effect that the USPTO's computer programs require that patent applicants reference both a serial number and indicate whether an application is a continuation or continuation in part. Stephen G. Kunin, Benefit of Prior-Filed Application, USPTO Electronic Official Gazette, Mar. 18, 2003 at http://www.uspto.gov/web/offices/com/sol/og/2003/week 11/patbene.htm. The present applicant entity has provided below a specific reference to the application(s)from which priority is being claimed as recited by statute. Applicant entity understands that the statute is unambiguous in its specific reference language and does not require either a serial number or any characterization such as “continuation” or “continuation-in-part.” Notwithstanding the foregoing, applicant entity understands that the USPTO's computer programs have certain data entry requirements, and hence applicant entity is designating the present application as a continuation in part of its parent applications, but expressly points out that such designations are not to be construed in any way as any type of commentary and/or admission as to whether or not the present application contains any new matter in addition to the matter of its parent application(s).

### RELATED APPLICATIONS

1. For purposes of the USPTO extra-statutory requirements, the present application constitutes a continuation in part of currently co-pending United States patent application entitled VIRTUAL CREDIT IN SIMULATED ENVIRONMENTS, naming Edward K. Y. Jung; Royce A. Levien; Mark A. Malamud and John D. Rinaldo, Jr. as inventors, U.S. application Ser. No. 11/051,514, filed Feb. 4, 2005.

2. For purposes of the USPTO extra-statutory requirements, the present application constitutes a continuation in part of currently co-pending United States patent application entitled FINANCIAL VENTURES BASED ON VIRTUAL CREDIT, naming Edward K. Y. Jung; Royce A. Levien; Mark A. Malamud and John D. Rinaldo, Jr. as inventors, U.S. application Ser. No. 11/069,894, filed Feb. 28, 2005.

3. For purposes of the USPTO extra-statutory requirements, the present application constitutes a continuation in part of currently co-pending United States patent application entitled VIRTUAL WORLD ESCROW ENVIRONMENT, naming Edward K. Y. Jung; Royce A. Levien; Mark A. Malamud and John D. Rinaldo, Jr. as inventors, U.S. application Ser. No. To be Assigned, filed substantially contemporaneoulsy herewith.

### TECHNICAL FIELD

The present application relates, in general, to conducting virtual world transactions.

### SUMMARY

In one aspect, a virtual reality environment includes but is not limited to a simulated world wherein a participant is enabled to select a destination and/or activity access to the simulated world and participate in an escrow arrangement as a grantor participant, as a depository participant, as at least one depository item available for deposit pursuant to the escrow arrangement, and/or as a grantee participant; a value system wherein a potential depository value is attributed to one or more depository items and a potential condition/event value is attributed to a performance of a condition and/or the happening of an event, wherein the one or more depository items are to be delivered by a grantor to a depository prior to the performance of the condition and/or the happening of the event, and wherein the one or more depository items are to be delivered by the depository to a grantee upon the performance of the condition and/or the happening of the event; and a memory device capable of keeping a record of the escrow arrangement. In addition to the foregoing, other method aspects are described in the claims, drawings, and text forming a part of the present application.

In one aspect, a method of conducting virtual world transactions includes but is not limited to providing an imaginary environment where a player is enabled to choose a destination and/or activity and/or event; creating an opportunity in the imaginary environment for the player to participate in an escrow transaction, wherein the escrow transaction involves a delivery of at least one depository item by a grantor to a depository prior to a performance of a condition and/or a happening of an event and a delivery of the at least one depository item by the depository to a grantee upon the performance of the condition and/or the happening of the event; and making a record of the escrow transaction. In addition to the foregoing, other method aspects are described in the claims, drawings, and text forming a part of the present application.

In one aspect, a system related to coducting virtual world transactions includes but is not limited to: circuitry for providing an imaginary environment where a player is enabled to choose a destination and/or activity and/or event; circuitry for creating an opportunity in the imaginary environment for the player to participate in an escrow transaction, wherein the escrow transaction involves a delivery of at least one depository item by a grantor to a depository prior to a performance of a condition and/or a happening of an event and a delivery of the at least one depository item by the depository to a grantee upon the performance of the condition and/or the happening of the event; and circuitry for making a record of the escrow transaction. In addition to the foregoing, other system aspects are described in the claims, drawings, and text forming a part of the present application.

In one or more various aspects, related systems include but are not limited to circuitry and/or programming and/or electromechanical devices and/or optical devices for effecting the herein-referenced method aspects; the circuitry and/or programming and/or electro-mechanical devices and/or optical devices can be virtually any combination of hardware, software, and/or firmware configured to effect the herein-referenced method aspects depending upon the design choices of the system designer skilled in the art.

In one aspect, a program product includes but is not limited to: a signal bearing medium bearing one or more instructions for providing an imaginary environment where a player is enabled to choose a destination and/or activity and/or event; one or more instructions for creating an opportunity in the imaginary environment for the player to participate in an escrow transaction, wherein the escrow transaction involves a delivery of at least one depository item by a grantor to a depository prior to a performance of a condition and/or a happening of an event and a delivery of the at least one depository item by the depository to a grantee upon the performance of the condition and/or the happening of the event; and one or more instructions for making a record of the escrow transaction. In addition to the foregoing, other program product aspects are described in the claims, drawings, and text forming a part of the present application.

In addition to the foregoing, various other method, system, and/or program product aspects are set forth and described in the teachings such as the text (e.g., claims and/or detailed description) and/or drawings of the present application.

The foregoing is a summary and thus contains, by necessity, simplifications, generalizations and omissions of detail; consequently, those skilled in the art will appreciate that the summary is illustrative only and is NOT intended to be in any way limiting. Other aspects, features, and advantages of the devices and/or processes and/or other subject matter described herein will become apparent in the teachings set forth herein.

### BRIEF DESCRIPTION OF THE FIGURES

FIG. 1 depicts one implementation of an exemplary environment in which the methods and systems described herein may be represented;

FIG. 2 depicts one implementation of an exemplary environment in which the methods and systems described herein may be represented;

FIG. 3 depicts several alternate implementations of aspects of the exemplary environment of FIG. 1;

FIG. 4 depicts several alternate implementations of aspects of the exemplary environment of FIG. 1;

FIG. 5 depicts several alternate implementations of aspects of the exemplary environment of FIG. 1;

FIG. 6 depicts a high-level logic flowchart of an operational process;

FIG. 7 shows several alternative implementations of the high-level logic flowchart of FIG. 6; and

FIG. 8 shows several alternative implementations of the high-level logic flowchart of FIG. 6.

The use of the same symbols in different drawings typically indicates similar or identical items.

### DETAILED DESCRIPTION

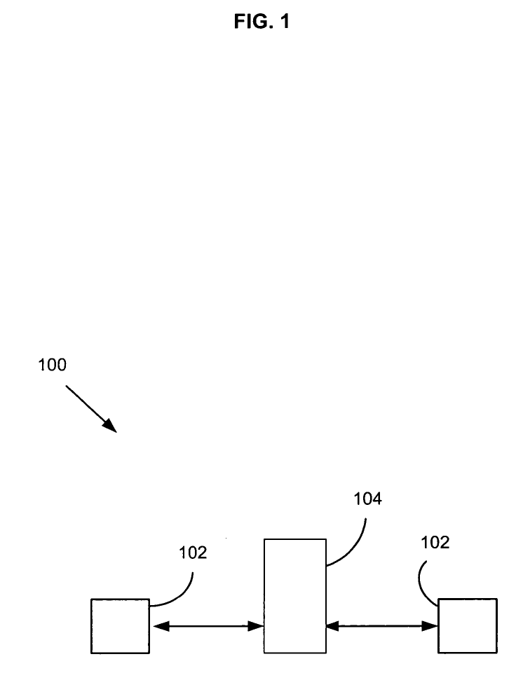

With reference to the figures, FIG. 1 depicts one implementation of an exemplary environment 100 in which the methods and systems described herein may be represented. Participant computers 102 are exemplary of any number of computers desirable to permit multiple participants in a simulated world and/or a virtual environment to participate in that simulated world and/or a virtual environment. The participant computers 102 may be laptop computers, desktop computers, handheld wireless devices and/or other computing devices or combinations of computing devices including tactile, visual, mechanical, and/or sonic user interface devices. Intermediate device 104 is exemplary of any and all intermediate devices that may provide paths and/or computational resources, e.g., one or more simulated-world/virtual-environment servers and/or transmission media, to provide the simulated-world/virtual-environment and to mediate the participation or participants via the participant computers 102.

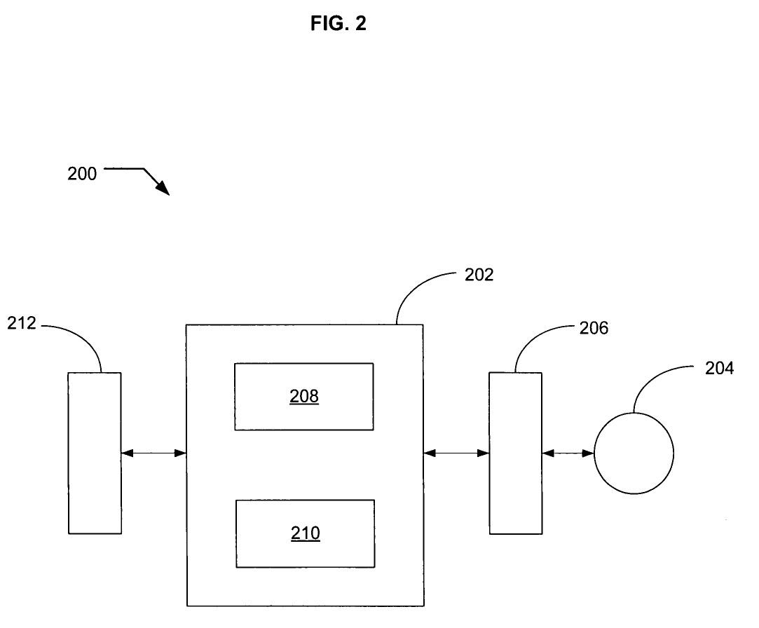

With reference to the figures, FIG. 2 depicts one implementation of an exemplary environment in which the methods and systems described herein may be represented. The virtual reality environment 200 comprises a simulated world 202 wherein a participant 204 is enabled to select a different destination and/or activity and/or event; a user interface communication link 206 that enables the participant 204 to have access to the simulated world 202 and participate in an escrow arrangement 208 as a grantor participant, a depository participant, at least one depository item available for deposit pursuant to the escrow arrangement, and/or a grantee participant; a value system 210 wherein a potential depository value is attributed to the one or more depository items and a potential condition/event value is attributed to a performance of a condition and/or the happening of an event, wherein the one or more depository items is to be delivered by a grantor to a depository prior to the performance of the condition and/or the happening of the event, and wherein the one or more depository items is to be delivered by the depository to a grantee upon the performance of the condition and/or the happening of the event; and a memory device 212 capable of keeping a record of the escrow arrangement. The simulated world 202 may include simulated locations and simulated features that either do or do not correspond to locations and features in the real world, such as cities, building, roads, and/or vehicles, and may enable the participant 204 to participate in simulated activities and events that either do or do not correspond to activities and events in the real world, such as financial transactions (e.g., sales, licenses, and leases) and barter transactions involving two or more parties. The simulated world 202 may be simulated using one or more computer programs running on one or more computers; the computers may be co-located or may communicate among themselves using hardware or wireless communication links, such as computers and communications links included in the Internet. The user interface communication link 206 may include hardware and/or wireless communications links with other computers involved in the simulated world 202, e.g., over the Internet by which the participant 204 may participate in the simulated world 202.

In the exemplary virtual reality environment 200, the user interface communication link 206 enables the participant to participate in one or more escrow arrangements 208 as a grantor participant (e.g., as a seller of a property), a depository participant (e.g., as an escrow agent), at least one depository item available for deposit pursuant to the escrow arrangement (e.g., as a slave or other chattel) and/or a grantee participant (e.g., as a buyer of a property).

In the exemplary virtual reality environment 200, the simulated world 202 includes the value system 210 wherein a potential depository value (e.g., in money or in terms or one or more goods and/or service) is attributed to one or more depository items (e.g., title to a property) and a potential condition/event value (e.g., in money or in terms or one or more goods and/or services) is attributed to a performance of a condition (e.g., payment for the property) and/or the happening of an event (e.g., approval of a loan for the purchase of the property), wherein the one or more depository items is to be delivered by a grantor (e.g., the owner of the property) to a depository (e.g., an escrow agent) prior to the performance of the condition and/or the happening of the event, and wherein the one or more depository items is to be delivered by the depository to a grantee (e.g., the buyer of the property) upon the performance of the condition and/or the happening of the event.

The exemplary virtual reality environment 200 includes the memory device 212, which may be co-located with any other computer resources used to simulate the simulated world 202 or located separately from them and in communication with them using hardware and/or wireless communication links.

One skilled in the art will recognize that the herein described components (e.g., steps), devices, and objects and the discussion accompanying them are used as examples for the sake of conceptual clarity and that various configuration modifications are within the skill of those in the art. Consequently, as used herein, the specific exemplars set forth and the accompanying discussion are intended to be representative of their more general classes. In general, use of any specific exemplar herein is also intended to be representative of its class, and the non-inclusion of such specific components (e.g., steps), devices, and objects herein should not be taken as indicating that limitation is desired.

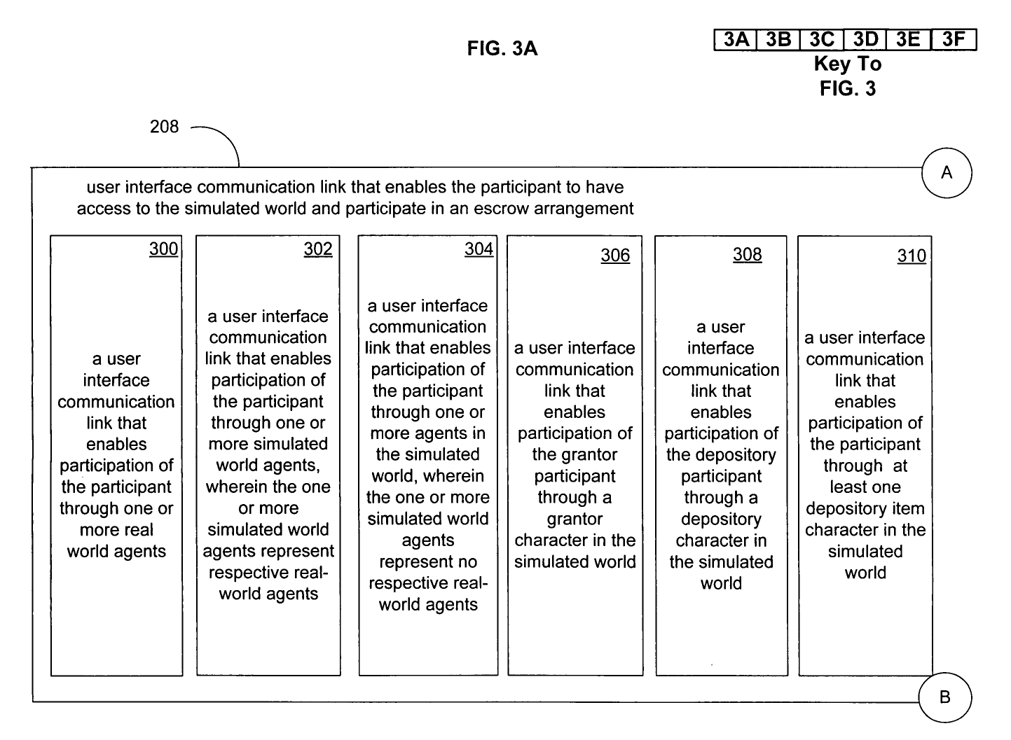

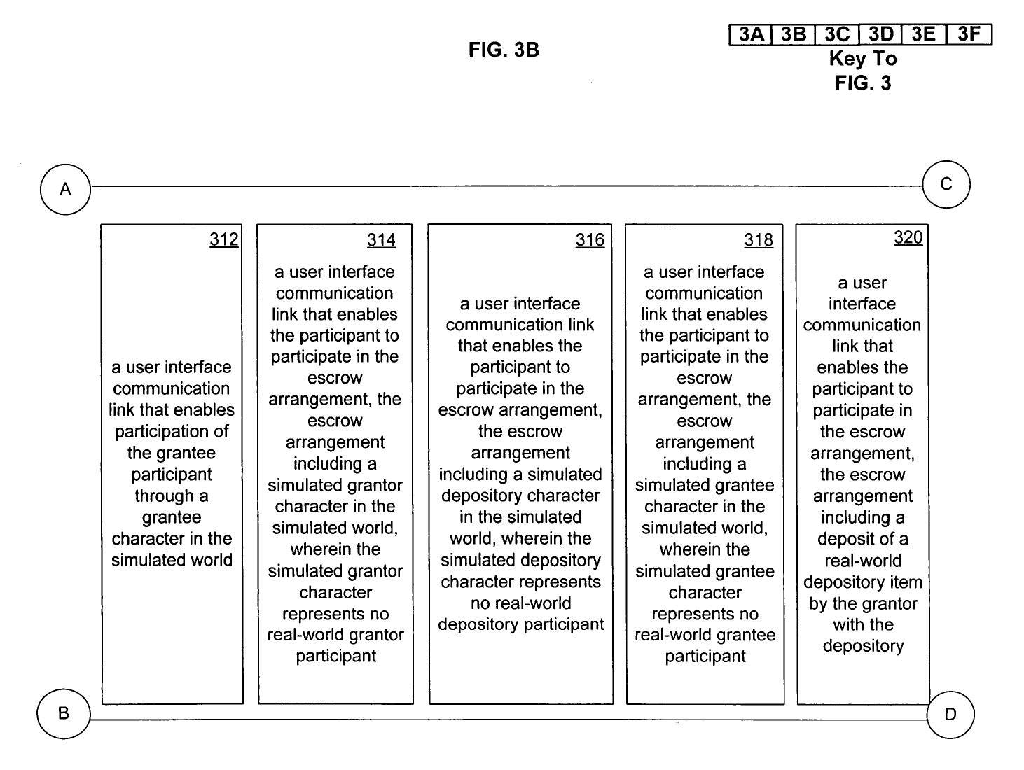

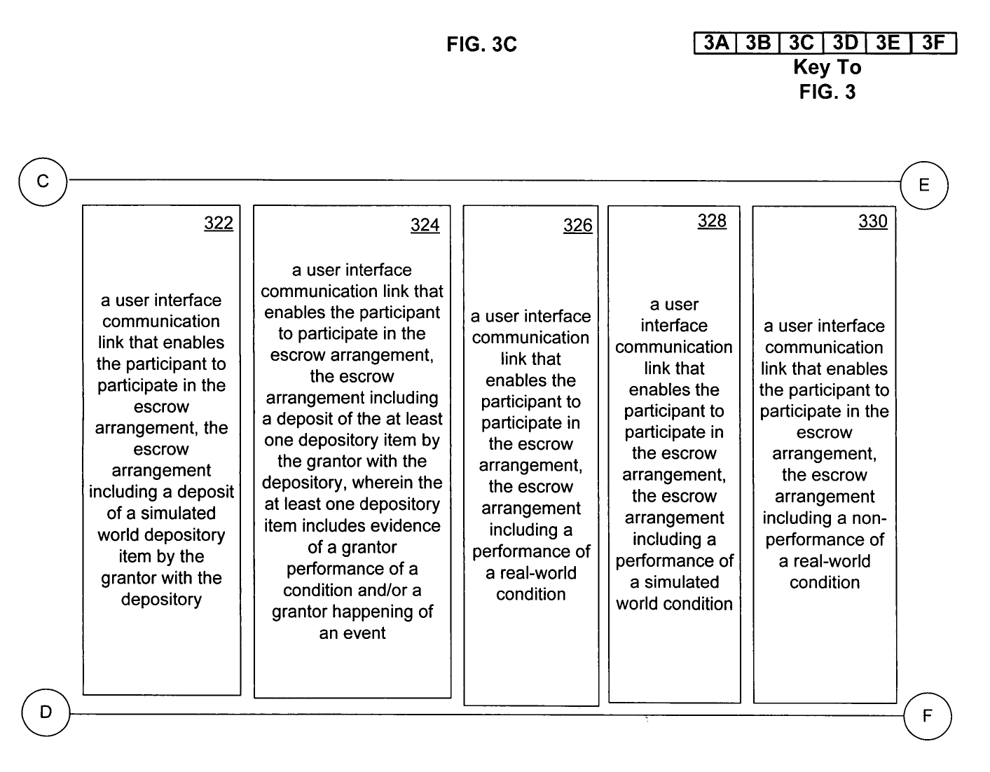

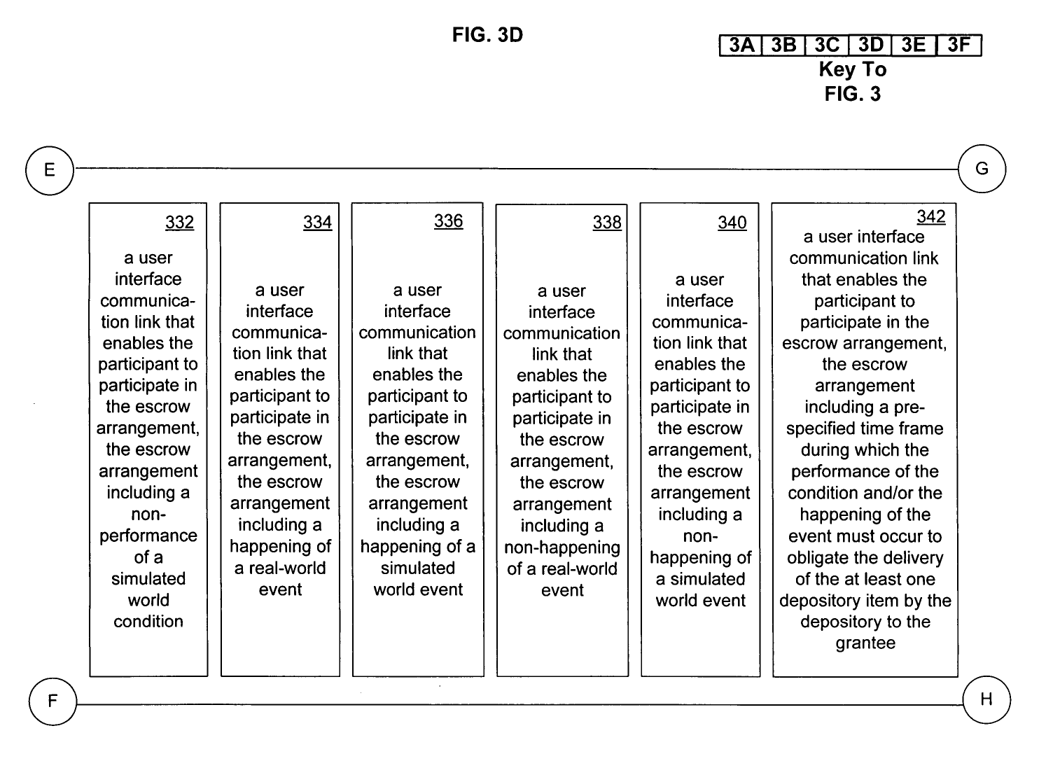

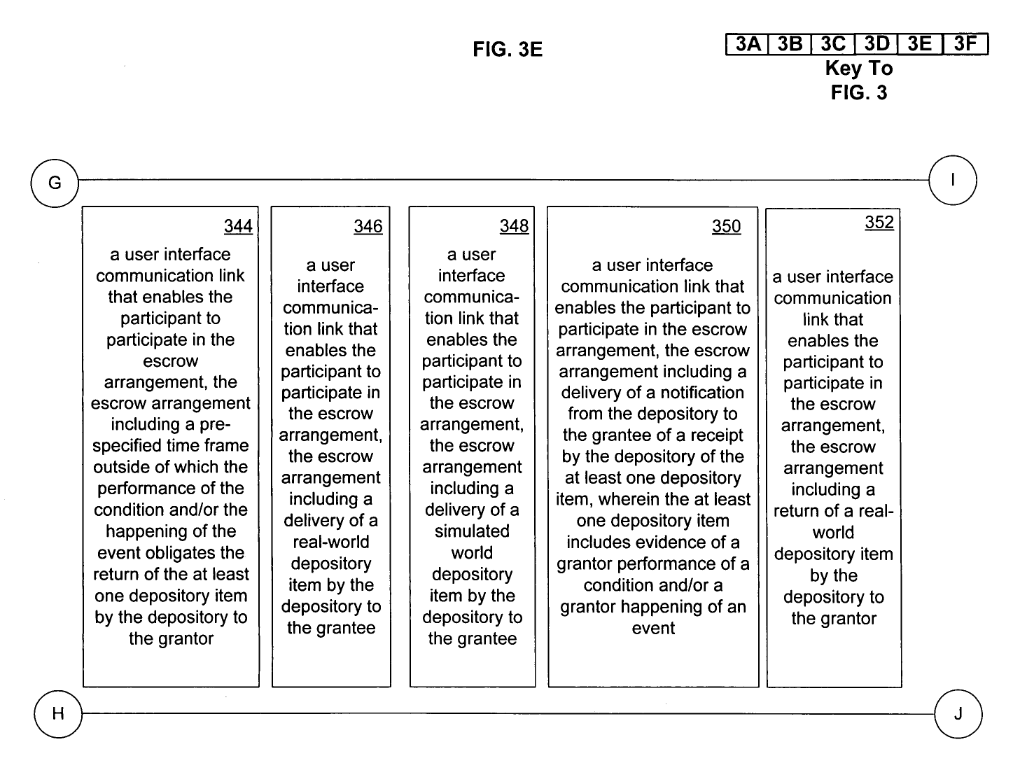

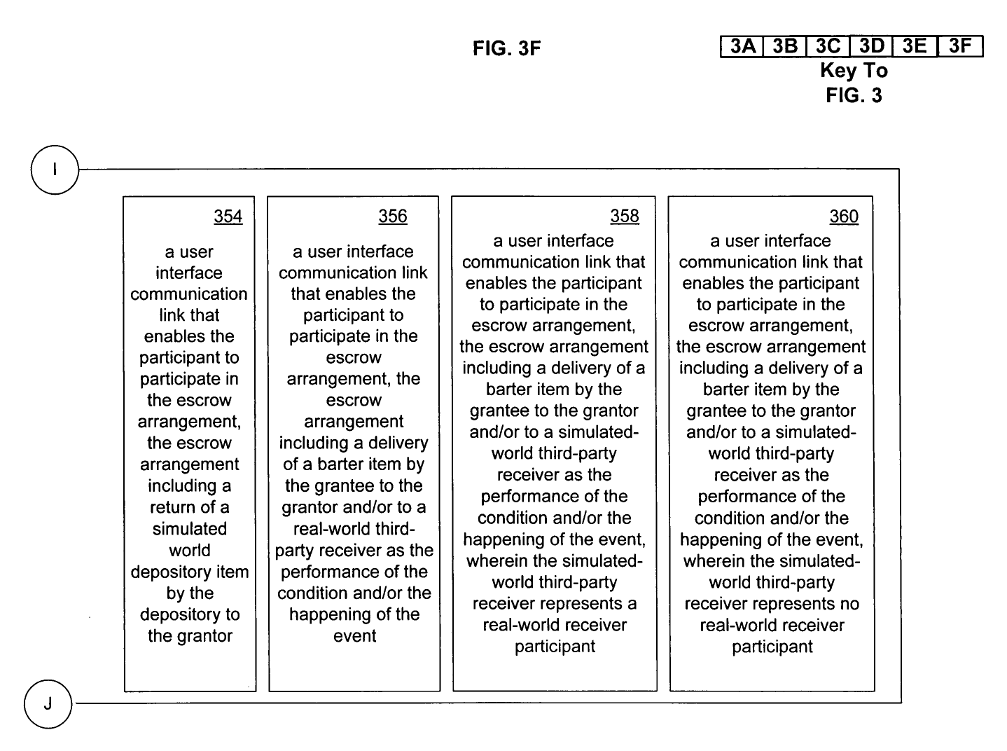

FIG. 3 depicts various exemplary features of the escrow arrangement 208. Depicted is that escrow arrangement 208 may include one or more of the features 300, 302, 304, 306, 308, 310, 312, 314, 316, 318, 320, 322, 324, 326, 328, 330, 332, 334, 336, 338, 340, 342, 344, 346, 348, 350, 352, 354, 356, 358, and/or 360. Feature 300 shows a user interface communication link that enables participation of the participant through one or more real world agents (e.g., a user interface communication link 206 that enables participation of the participant 204 in the simulated world 202 through a second real world person and/or robotic entity executing the instructions of the participant 204 in the simulated world 202). Feature 302 depicts a user interface communication link that enables participation of the participant through one or more simulated world agents, wherein the one or more simulated world agents represent respective real-world agents (e.g., a user interface communication link 206 that enables participation of the participant 204 in the simulated world 202 through a simulated character in the simulated world 202, acting on the instructions of the participant 204 in the simulated world 202, where this simulated character represents another participant 204). Feature 304 illustrates a user interface communication link that enables participation of the participant through one or more agents in the simulated world, wherein the one or more simulated world agents represent no respective real-world agents (e.g., a user interface communication link 206 that enables participation of the participant 204 in the simulated world 202 through a simulated character in the simulated world 202, where this simulated character does not correspond to any real-world participant 204 and acts on the instructions of the participant 204 in the simulated world 202). Feature 306 depicts a user interface communication link that enables participation of the grantor participant through a grantor character in the simulated world (e.g., a user interface communication link 206 that enables the direct participation of the participant 204 in the simulated world 202 through a simulated grantor character, e.g., a seller of property). Feature 308 shows a user interface communication link that enables participation of the depository participant through a depository character in the simulated world (e.g., a user interface communication link 206 that enables the direct participation of the participant 204 in the simulated world 202 through a simulated depository character, e.g., an escrow agent, in the simulated world 202). Feature 310 illustrates a user interface communication link that enables participation of the participant through at least one depository item character in the simulated world (e.g., a user interface communication link 206 that enables the direct participation of the participant 204 in the simulated world 202 through a simulated depository item, e.g., a slave or other chattel such as an animal). Feature 312 shows a user interface communication link that enables participation of the grantee participant through a grantee character in the simulated world (e.g., a user interface communication link 206 that enables the direct participation of the participant 204 in the simulated world 202 through a simulated grantee character, e.g., a buyer of property, in the simulated world 202).

Feature 314 illustrates a user interface communication link that enables the participant to participate in the escrow arrangement, the escrow arrangement including a simulated grantor character in the simulated world, wherein the simulated grantor character represents no real-world grantor participant (e.g., a user interface communication link 206 that enables the participant 204 to participate in the escrow arrangement that includes a simulated seller of property in simulated world 202, where the simulated seller does not correspond to any participant 204). Feature 316 shows a user interface communication link that enables the participant to participate in the escrow arrangement, the escrow arrangement including a simulated depository character in the simulated world, wherein the simulated depository character represents no real-world depository participant (e.g., a user interface communication link 206 that enables the participant 204 to participate in the escrow, arrangement that includes a simulated escrow agent in the simulated world 202, where the simulated escrow agent does not correspond to any participant 204). Feature 318 depicts a user interface communication link that enables the participant to participate in the escrow arrangement, the escrow arrangement including a simulated grantee character in the simulated world, wherein the simulated grantee character represents no real-world grantee participant (e.g., a user interface communication link 206 that enables the participant 204 to participate in the escrow arrangement that includes a simulated buyer of property in the simulated world 202, where the simulated buyer does not correspond to any participant 204). Feature 320 illustrates a user interface communication link that enables the participant to participate in the escrow arrangement, the escrow arrangement including a deposit of a real-world depository item by the grantor with the depository (e.g., a user interface communication link 206 that enables the participant 204 to participate in the escrow arrangement that includes a deposit by the participant 204 of a real-world depository item, such as a property deed, with a real-world escrow agent). Feature 322 shows a user interface communication link that enables the participant to participate in the escrow arrangement, the escrow arrangement including a deposit of a simulated world depository item by the grantor with the depository (e.g., a user interface communication link 206 that enables the participant 204 to participate in the escrow arrangement that includes a deposit by the participant 204 of a simulated depository item, such as a property deed for a simulated property, with a simulated escrow agent). Feature 324 depicts a user interface communication link that enables the participant to participate in the escrow arrangement, the escrow arrangement including a deposit of the at least one depository item by the grantor with the depository, wherein the at least one depository item includes evidence of a grantor performance of a condition and/or a grantor happening of an event (e.g., a user interface communication link 206 that enables the participant 204 to participate in the escrow arrangement that includes a deposit with an escrow agent by a participant 204 of an affidavit attesting to the performance of a condition, such as a payment, or of a letter attesting to the happening of an event, such as an approval of a loan). Feature 326 shows a user interface communication link that enables the participant to participate in the escrow arrangement, the escrow arrangement including a performance of a real-world condition (e.g., a user interface communication link 206 that enables the participant 204 to participate in the escrow arrangement that includes a performance by a participant 204 of a real-world payment).

Feature 328 depicts a user interface communication link that enables the participant to participate in the escrow arrangement, the escrow arrangement including a performance of a simulated world condition (e.g., a user interface communication link 206 that enables the participant 204 to participate in the escrow arrangement that includes a performance by a participant 204 of a payment in the simulated world 202). Feature 330 illustrates a user interface communication link that enables the participant to participate in the escrow arrangement, the escrow arrangement including a non-performance of a real-world condition (e.g., a user interface communication link 206 that enables the participant 204 to participate in the escrow arrangement that includes a non-performance by a participant 204 of a payment in the real-world). Feature 332 shows a user interface communication link that enables the participant to participate in the escrow arrangement, the escrow arrangement including a non-performance of a simulated world condition (e.g., a user interface communication link 206 that enables the participant 204 to participate in the escrow arrangement that includes a non-performance by a participant 204 of a payment in the simulated world 202). Feature 334 shows a user interface communication link that enables the participant to participate in the escrow arrangement, the escrow arrangement including a happening of a real-world event (e.g., a user interface communication link 206 that enables the participant 204 to participate in the escrow arrangement that includes an approval of a loan to the participant 204 in the real world). Feature 336 depicts a user interface communication link that enables the participant to participate in the escrow arrangement, the escrow arrangement including a happening of a simulated world event (e.g., a user interface communication link 206 that enables the participant 204 to participate in the escrow arrangement that includes an approval of a loan to the participant 204 in the simulated world 202). Feature 338 illustrates a user interface communication link that enables the participant to participate in the escrow arrangement, the escrow arrangement including a non-happening of a real-world event (e.g., a user interface communication link 206 that enables the participant 204 to participate in the escrow arrangement that includes a non-approval of a loan to the participant 204 in the real world). Feature 340 shows a user interface communication link that enables the participant to participate in the escrow arrangement, the escrow arrangement including a non-happening of a simulated world event (e.g., a user interface communication link 206 that enables the participant 204 to participate in the escrow arrangement that includes a non-approval of a loan to the participant 204 in the simulated world 202). Feature 342 depicts a user interface communication link that enables the participant to participate in the escrow arrangement, the escrow arrangement including a pre-specified time frame during which the performance of the condition and/or the happening of the event must occur to obligate the delivery of the at least one depository item by the depository to the grantee (e.g., a user interface communication link 206 that enables the participant 204 to participate in the escrow arrangement that includes a pre-specified period of seven days, during which a participant 204 must tender payment as a buyer to obligate the escrow agent to deliver a deed of property to the participant 204).

Feature 344 shows a user interface communication link that enables the participant to participate in the escrow arrangement, the escrow arrangement including a pre-specified time frame outside of which the performance of the condition and/or the happening of the event obligates the return of the at least one depository item by the depository to the grantor (e.g., a user interface communication link 206 that enables the participant 204 to participate in the escrow arrangement that includes a pre-specified period of seven days, outside of which the tendering of a payment by a participant 204 as a buyer obligates the escrow agent to return a deed of property to the seller). Feature 346 illustrates a user interface communication link that enables the participant to participate in the escrow arrangement, the escrow arrangement including a delivery of a real-world depository item by the depository to the grantee (e.g., a user interface communication link 206 that enables the participant 204 to participate in the escrow arrangement that includes a delivery of a real-world deed of property by an escrow agent to a participant 204 buyer). Feature 348 illustrates a user interface communication link that enables the participant to participate in the escrow arrangement, the escrow arrangement including a delivery of a simulated world depository item by the depository to the grantee (e.g., a user interface communication link 206 that enables the participant 204 to participate in the escrow arrangement that includes a delivery of a simulated deed of property in the simulated world 202 by an escrow agent to a participant 204 buyer). Feature 350 depicts a user interface communication link that enables the participant to participate in the escrow arrangement, the escrow arrangement including a delivery of a notification from the depository to the grantee of a receipt by the depository of the at least one depository item, wherein the at least one depository item includes evidence of a grantor performance of a condition and/or a grantor happening of an event (e.g., a user interface communication link 206 that enables the participant 204 to participate in the escrow arrangement that includes a delivery of a notification from the escrow agent to seller participant 204 of a receipt by the escrow agent of evidence of a payment by a buyer). Feature 352 shows a user interface communication link that enables the participant to participate in the escrow arrangement, the escrow arrangement including a return of a real-world depository item by the depository to the grantor (e.g., a user interface communication link 206 that enables the participant 204 to participate in the escrow arrangement that includes a return to a seller participant 204 of a real-world deed of property). Feature 354 depicts a user interface communication link that enables the participant to participate in the escrow arrangement, the escrow arrangement including a return of a simulated world depository item by the depository to the grantor (e.g., a user interface communication link 206 that enables the participant 204 to participate in the escrow arrangement that includes a return to a seller participant 204 of a simulated deed of property in the simulated world 202).

Feature 356 illustrates a user interface communication link that enables the participant to participate in the escrow arrangement, the escrow arrangement including a delivery of a barter item by the grantee to the grantor and/or to a real-world third-party receiver as the performance of the condition and/or the happening of the event (e.g., a user interface communication link 206 that enables the participant 204 to participate in the escrow arrangement that includes a delivery of one or more goods and/or services by a participant 204 to a real-world person and/or third party (either the escrow agent or someone else) in a barter deal to fulfill a condition of the barter deal). Feature 358 depicts a user interface communication link that enables the participant to participate in the escrow arrangement, the escrow arrangement including a delivery of a barter item by the grantee to the grantor and/or to a simulated-world third-party receiver as the performance of the condition and/or the happening of the event, wherein the simulated-world third-party receiver represents a real-world receiver participant (e.g., a user interface communication link 206 that enables the participant 204 to participate in the escrow arrangement that includes a delivery of one or more goods and/or services to a person or a third party in the simulated world 202 (corresponding to either the escrow agent or someone else in the real-world) in a barter deal to fulfill a condition of the barter deal). Feature 360 shows a user interface communication link that enables the participant to participate in the escrow arrangement, the escrow arrangement including a delivery of a barter item by the grantee to the grantor and/or to a simulated-world third-party receiver as the performance of the condition and/or the happening of the event, wherein the simulated-world third-party receiver represents no real-world receiver participant (e.g., a user interface communication link 206 that enables the participant 204 to participate in the escrow arrangement that includes a delivery of one or more goods and/or services to a person or a third party in the simulated world 202 (corresponding to no-one in the real-world) in a barter deal to fulfill a condition of the barter deal).

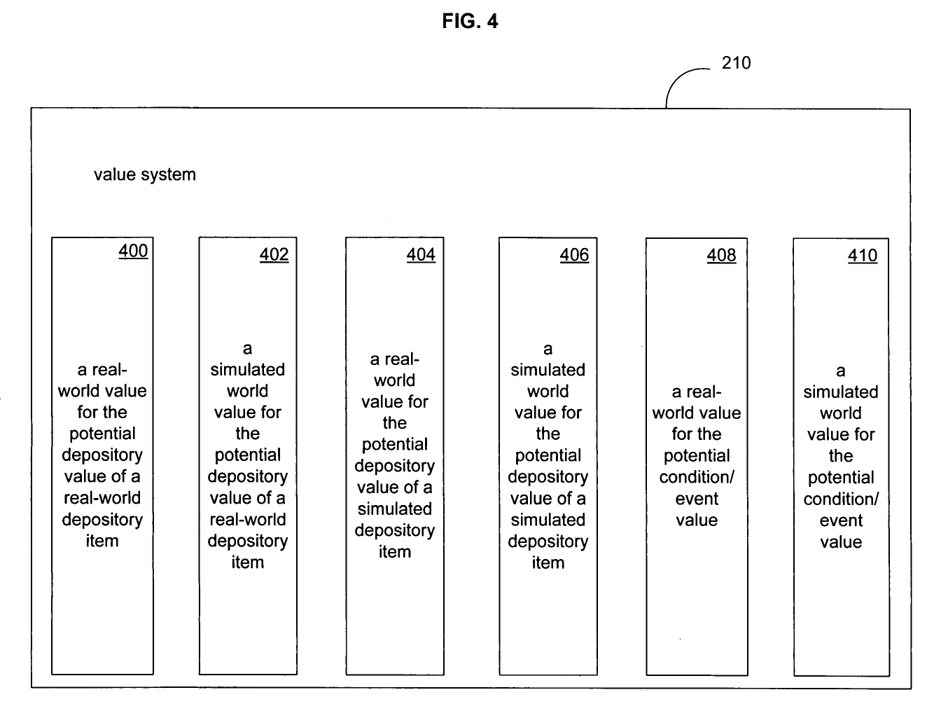

FIG. 4 depicts features of the value system 210. Depicted is that value system 210 may include one or more of the features 400, 402, 404, 406, 408, and 410. Feature 400 shows a real-world value for the potential depository value of a real-world depository item (e.g., a value in U.S. dollars for the potential depository value of a real-world deed of property). Feature 402 illustrates a simulated world value for the potential depository value of a real-world depository item (e.g., a value in simulated currency in the simulated world 202 for the potential depository value of a real-world deed of property). Feature 404 depicts a real-world value for the potential depository value of a simulated depository item (e.g., a value in kind in the real world for the potential depository value of a simulated chattel). Feature 406 depicts a simulated world value for the potential depository value of a simulated depository item (e.g., a value in kind in the simulated world 202 for the potential depository value of a simulated chattel in the simulated world 202). Feature 408 shows a real-world value for the potential condition/event value (e.g., a value in real-world European Union Euros for the potential condition/event value of the performance of a service, such as painting a house). Feature 410 depicts a simulated world value for the potential condition/event value (e.g., a value in simulated currency in the simulated world 202 for the potential condition/event value of the performance of a service, such as painting a house).

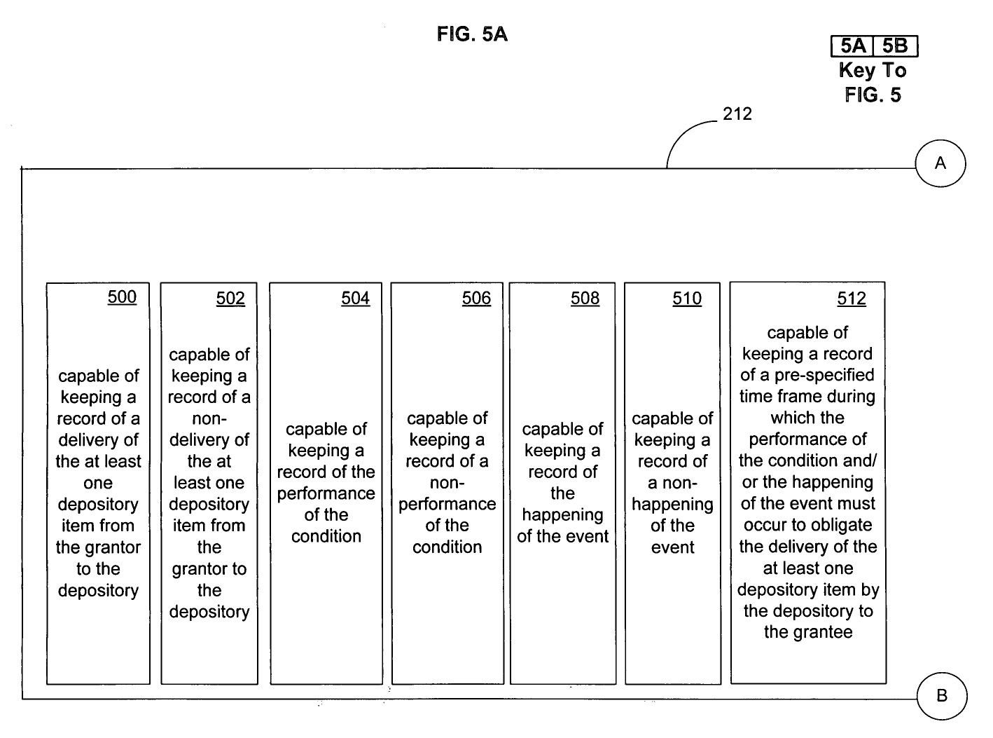

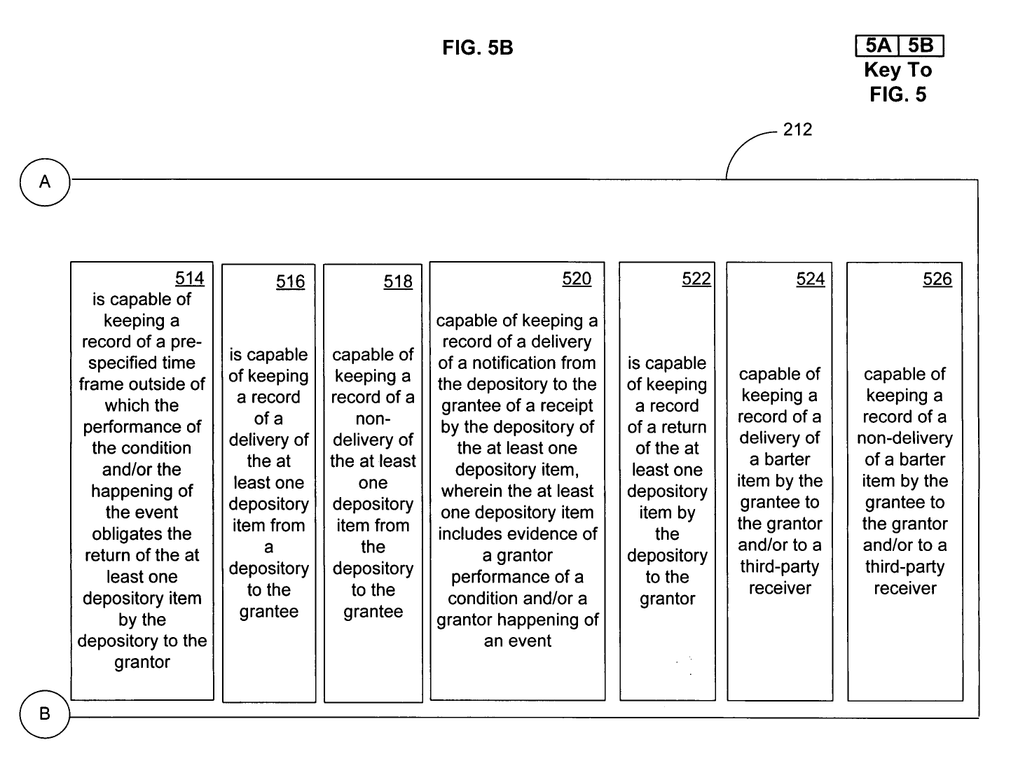

FIG. 5 depicts features of the memory device 212. Depicted is that memory device 212 may include one or more of the features 500, 502, 504, 506, 508, 510, 512, 514, 516, 518, 520, 522, 524, and/or 526. Feature 500 shows the memory device 212 capable of keeping a record of a delivery of the at least one depository item from the grantor to the depository (e.g., the memory device 212 capable of keeping a record of a delivery of a property deed from a seller to an escrow agent participant 204). Feature 502 illustrates the memory device 212 capable of keeping a record of a non-delivery of the at least one depository item from the grantor to the depository (e.g., the memory device 212 capable of keeping a record of a non-delivery of a property deed from a seller to an escrow agent participant 204). Feature 504 depicts the memory device 212 capable of keeping a record of the performance of the condition (e.g., the memory device 212 capable of keeping a record of a payment by the participant 204). Feature 506 depicts the memory device 212 capable of keeping a record of a non-performance of the condition (e.g., the memory device 212 capable of keeping a record of a failure to make a payment to the participant 204). Feature 508 illustrates the memory device 212 capable of keeping a record of the happening of the event (e.g., the memory device 212 capable of keeping a record of an approval of a loan to the participant 204). Feature 510 shows the memory device 212 capable of keeping a record of a non-happening of the event (e.g., the memory device 212 capable of keeping a record of a non-approval of a loan to a prospective buyer of property from the participant 204). Feature 512 depicts the memory device 212 capable of keeping a record of a pre-specified time frame during which the performance of the condition and/or the happening of the event must occur to obligate the delivery of the at least one depository item by the depository to the grantee (e.g., the memory device 212 capable of keeping a record of a pre-specified three-month period during which a making of a payment by the participant 204 must occur to obligate the delivery of a property deed to the participant 204). Feature 514 shows the memory device 212 capable of keeping a record of a pre-specified time frame outside of which the performance of the condition and/or the happening of the event obligates the return of the at least one depository item by the depository to the grantor (e.g., the memory device 212 capable of keeping a record of a two-week period outside of which a making of a payment by a prospective buyer obligates the return of a chattel to a prospective seller participant 204). Feature 516 illustrates the memory device 212 capable of keeping a record of a delivery of the at least one depository item from a depository to the grantee (e.g., the memory device 212 capable of keeping a record of a delivery of a chattel from an escrow agent to a buyer participant 204). Feature 518 shows the memory device 212 capable of keeping a record of a non-delivery of the at least one depository item from the depository to the grantee (e.g., the memory device 212 capable of keeping a record of a non-delivery of a property deed from an escrow agent participant 204 to a buyer). Feature 520 shows the memory device 212 capable of keeping a record of a delivery of a notification from the depository to the grantee of a receipt by the depository of the at least one depository item, wherein the at least one depository item includes evidence of a grantor performance of a condition and/or a grantor happening of an event (e.g., the memory device 212 capable of keeping a record of a delivery of a notification by an escrow agent to a prospective seller participant 204 of receipt by the escrow agent of evidence of approval of a loan to a prospective buyer). Feature 522 depicts the memory device 212 capable of keeping a record of a return of the at least one depository item by the depository to the grantor (e.g., the memory device 212 capable of keeping a record of a return of a chattel participant 204 to a prospective seller by the escrow agent). Feature 524 illustrates the memory device 212 capable of keeping a record of a delivery of a barter item by the grantee to the grantor and/or to a third-party receiver (e.g., the memory device 212 capable of keeping a record of a delivery of one or more goods and/or services by a participant 204 to a person and/or third party (either the escrow agent or someone else)). Feature 526 illustrates the memory device 212 capable of keeping a record of a non-delivery of a barter item by the grantee to the grantor and/or to a third-party receiver (e.g., the memory device 212 capable of keeping a record of a non-delivery of one or more goods and/or services by a participant 204 to a person and/or third party (either the escrow agent or someone else)).

Following are a series of flowcharts depicting implementations of processes. For ease of understanding, the flowcharts are organized such that the initial flowcharts present implementations via an overall “big picture” viewpoint and thereafter the following flowcharts present alternate implementations and/or expansions of the “big picture” flowcharts as either sub-steps or additional steps building on one or more earlier-presented flowcharts. Those having skill in the art will appreciate that the style of presentation utilized herein (e.g., beginning with a presentation of a flowchart(s) presenting an overall view and thereafter providing additions to and/or further details in subsequent flowcharts) generally allows for a rapid and easy understanding of the various process implementations. In addition, those skilled in the art will further appreciate that the style of presentation used herein also lends itself well to modular and/or object-oriented program design paradigms.

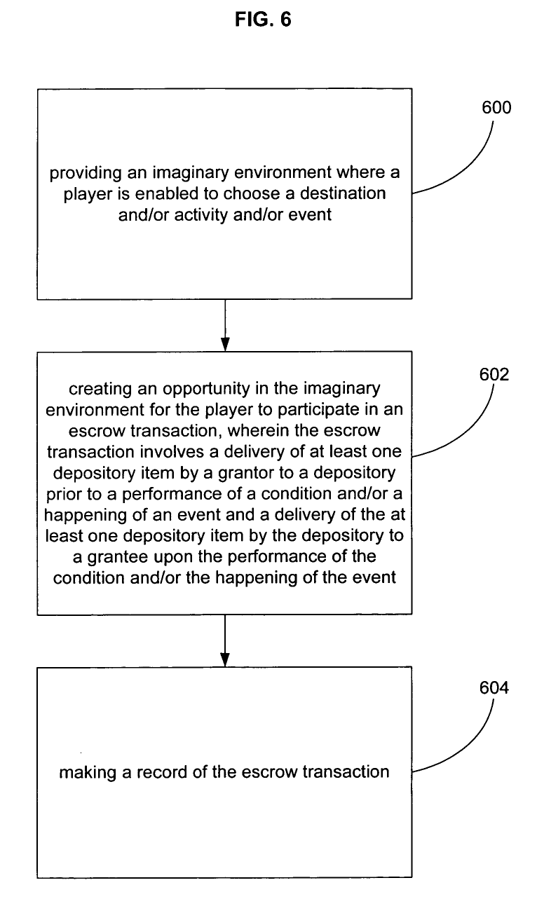

FIG. 6 depicts a high-level logic flowchart of an exemplary operational process. Operation 600 shows providing an imaginary environment where a player is enabled to choose a destination and/or activity and/or event (e.g., providing an Internet-based and Internet-accessed environment, such as the simulated world 202, that includes locations, features, and characters that do not correspond to locations, features, and people in the real world). Operation 602 depicts creating an opportunity in the imaginary environment for the player to participate in an escrow transaction, wherein the escrow transaction involves a delivery of at least one depository item by a grantor to a depository prior to a performance of a condition and/or a happening of an event and a delivery of the at least one depository item by the depository to a grantee upon the performance of the condition and/or the happening of the event (e.g., creating an opportunity in the simulated world 202 for the participant 204 to participate in the escrow arrangement 208 via the user interface communication link 206). Operation 604 illustrates making a record of the escrow transaction (e.g., making a record of the escrow arrangement 208 using the memory device 212).

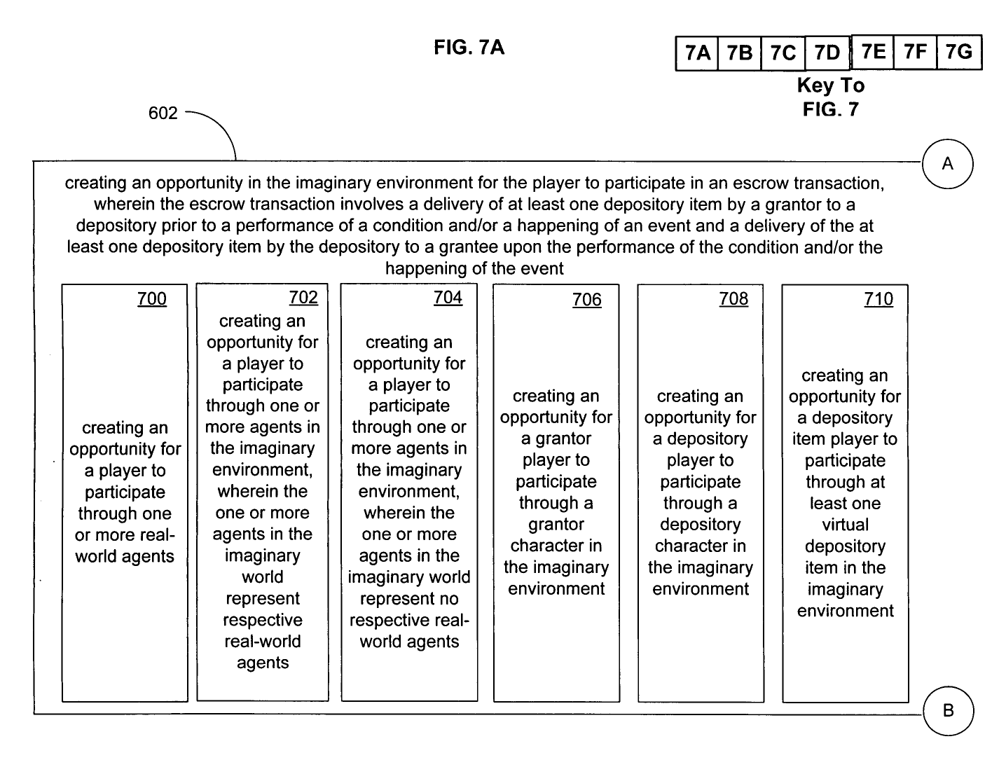

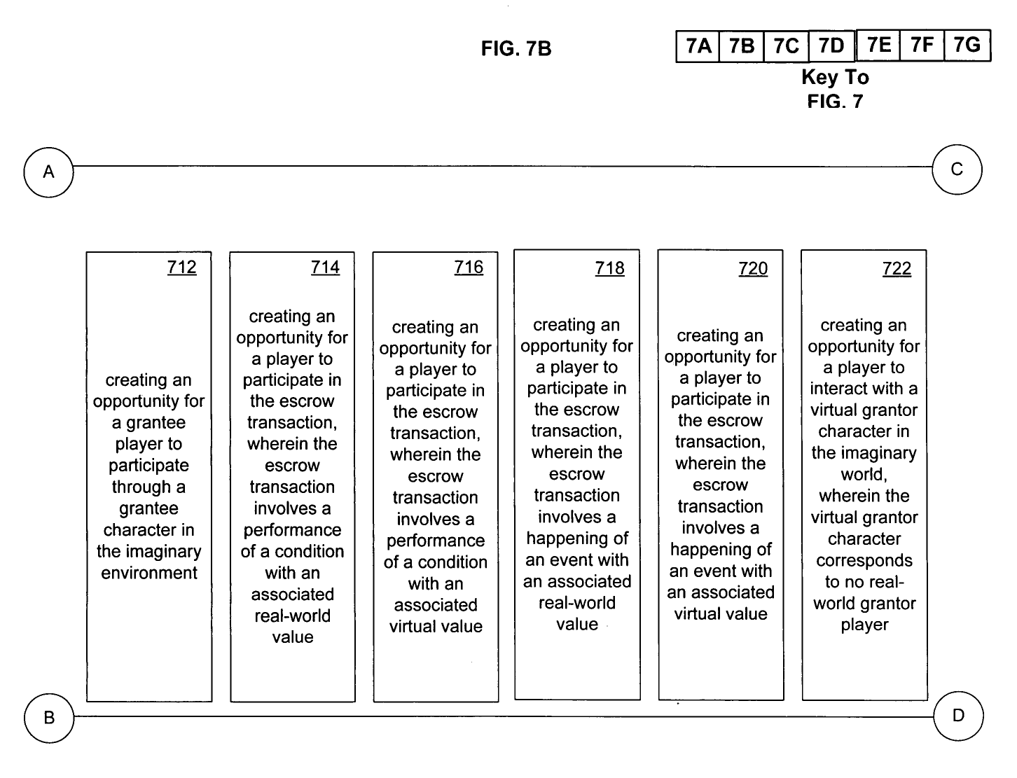

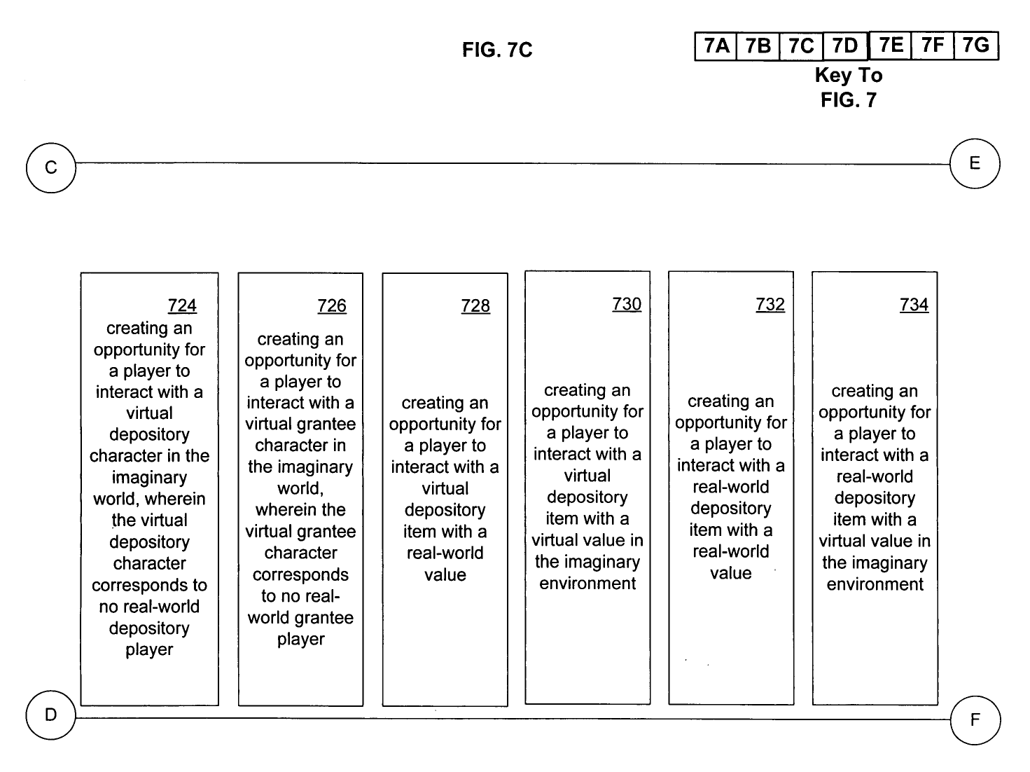

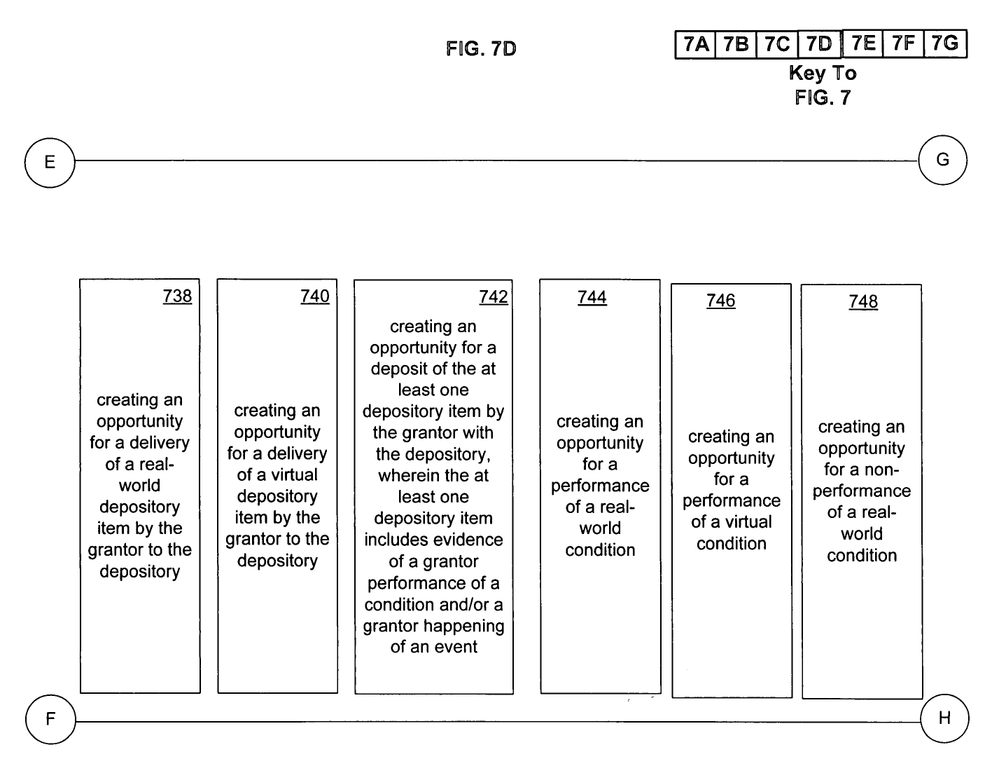

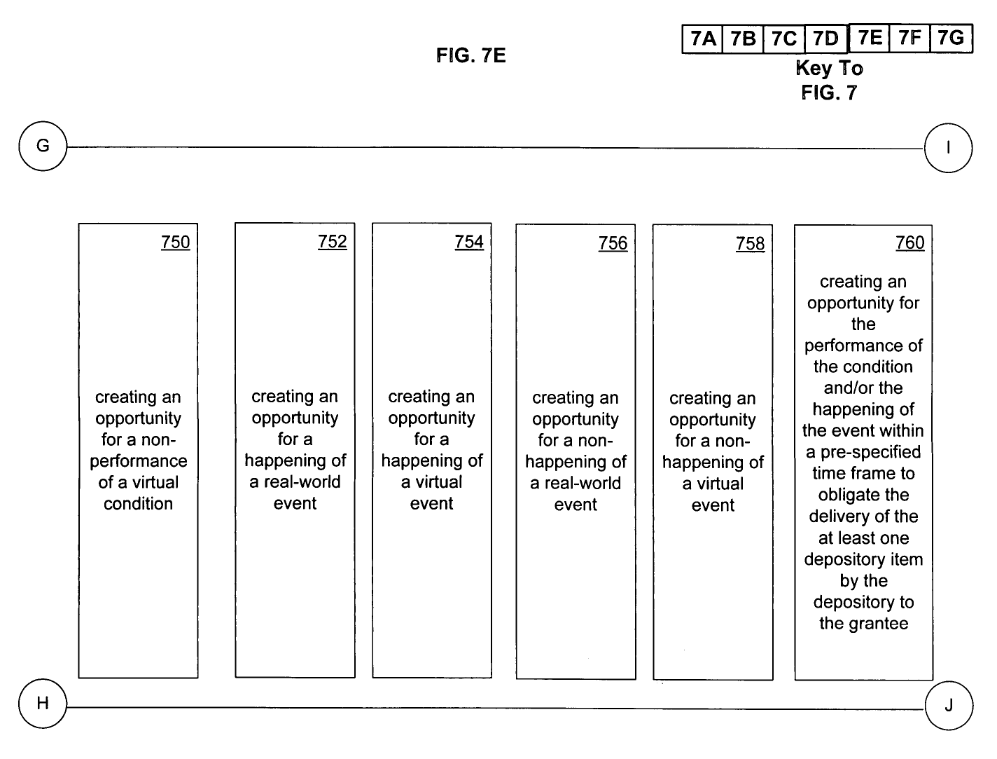

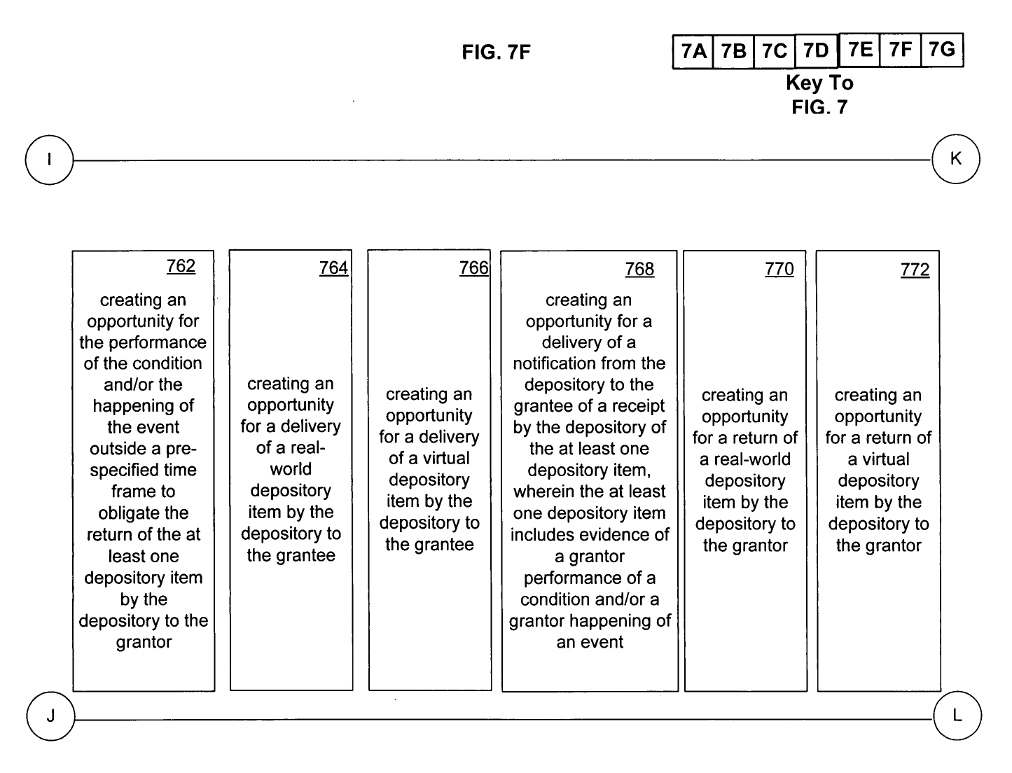

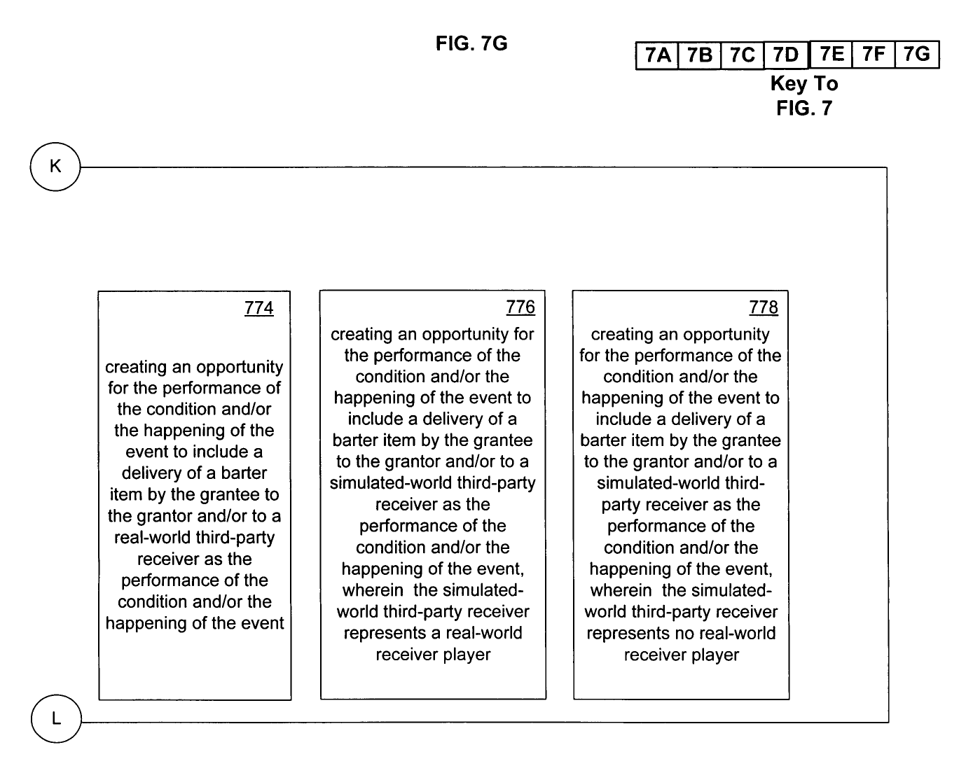

FIG. 7 shows several alternative implementations of the high-level logic flowchart of FIG. 6. Depicted is that operation 602 treating an opportunity in the imaginary environment for the player to participate in an escrow transaction, wherein the escrow transaction involves a delivery of at least one depository item by a grantor to a depository prior to a performance of a condition and/or a happening of an event and a delivery of the at least one depository item by the depository to a grantee upon the performance of the condition and/or the happening of the event-may include one or more of the following operations: 700, 702, 704, 706, 708, 710, 712, 714, 716, 718, 720, 722, 724, 726, 728, 730, 732, 734, 738, 740, 742, 744, 746, 748, 750, 752, 754, 756, 758, 760, 762, 764, 766, 768, 770, 772, 774, 776, and/or 778. Operation 700 shows creating an opportunity for a player to participate through one or more real-world agents (e.g., creating an opportunity for the participant 204 to participate in the simulated world 202 by having a second real world person execute the instructions of the participant 204 in the simulated world 202). Operation 702 illustrates creating an opportunity for a player to participate through one or more agents in the imaginary environment, wherein the one or more agents in the imaginary world represent respective real-world agents (e.g., creating an opportunity for the participant 204 to participate in the simulated world 202 through a simulated character in the simulated world 202 which represents another participant 204 who is executing the instructions of the first participant 204). Operation 704 depicts creating an opportunity for a player to participate through one or more agents in the imaginary environment, wherein the one or more agents in the imaginary world represent no respective real-world agents (e.g., creating an opportunity for the participant 204 to participate in the simulated world 202 through a simulated character in the simulated world 202 that does not correspond to a real-world participant 204). Operation 706 depicts creating an opportunity for a grantor player to participate through a grantor character in the imaginary environment (e.g., creating an opportunity for the participant 204 to participate in the simulated world 202 through a simulated grantor character, e.g., a seller of property). Operation 708 illustrates creating an opportunity for a depository player to participate through a depository character in the imaginary environment (e.g., creating an opportunity for the participant 204 to participate in the simulated world 202 through a simulated depository character, e.g., an escrow agent). Operation 710 shows creating an opportunity for a depository item player to participate through at least one virtual depository item in the imaginary environment (e.g., creating an opportunity for the participant 204 to participate in the simulated world 202 through a simulated depository item, e.g., a slave or other chattel such as an animal).

Operation 712 illustrates creating an opportunity for a grantee player to participate through a grantee character in the imaginary environment (e.g., creating an opportunity for the participant 204 to participate in the simulated world 202 through a simulated grantee character, e.g., a buyer of property). Operation 714 depicts creating an opportunity for a player to participate in the escrow transaction, wherein the escrow transaction involves a performance of a condition with an associated real-world value (e.g., creating an opportunity for the participant 204 to participate in the escrow arrangement 208 in the simulated world 202, where the escrow arrangement 208 includes a performance of a simulated service with an associated value in U.S. dollars). Operation 716 shows creating an opportunity for a player to participate in the escrow transaction, wherein the escrow transaction involves a performance of a condition with an associated virtual value (e.g., creating an opportunity for the participant 204 to participate in the escrow arrangement 208 in the simulated world 202, where the escrow arrangement 208 includes a performance of a service in terms of a simulated currency in the simulated world 202). Operation 718 shows creating an opportunity for a player to participate in the escrow transaction, wherein the escrow transaction involves a happening of an event with an associated real-world value (e.g., creating an opportunity for the participant 204 to participate in the escrow arrangement 208 in the simulated world 202, where the escrow arrangement 208 includes the approval of a loan with an associated value in real-world property). Operation 720 depicts creating an opportunity for a player to participate in the escrow transaction, wherein the escrow transaction involves a happening of an event with an associated virtual value (e.g., creating an opportunity for the participant 204 to participate in the escrow arrangement 208 in the simulated world 202, where the escrow arrangement 208 includes the approval of a loan with an associated value in terms of simulated services, such as the painting of a house in the simulated world 202). Operation 722 illustrates creating an opportunity for a player to interact with a virtual grantor character in the imaginary world, wherein the virtual grantor character corresponds to no real-world grantor player (e.g., creating an opportunity for the participant 204 to interact in the simulated world 202 with a virtual seller of property in the simulated world 202, where the virtual seller does not correspond to a real-world person).

Operation 724 illustrates creating an opportunity for a player to interact with a virtual depository character in the imaginary world, wherein the virtual depository character corresponds to no real-world depository player (e.g., creating an opportunity for the participant 204 to interact in the simulated world 202 with a virtual escrow agent, where the virtual escrow agent does not correspond to a real-world person). Operation 726 depicts creating an opportunity for a player to interact with a virtual grantee character in the imaginary world, wherein the virtual grantee character corresponds to no real-world grantee player (e.g., creating an opportunity for the participant 204 to interact in the simulated world 202 with a virtual buyer, where the virtual buyer does not correspond to a real-world person). Operation 728 shows creating an opportunity for a player to interact with a virtual depository item with a real-world value (e.g., creating an opportunity for the participant 204 to interact in the simulated world 202 with a virtual chattel such as a horse, where the virtual horse has a real-world value in European Union Euros). Operation 730 depicts creating an opportunity for a player to interact with a virtual depository item with a virtual value in the imaginary environment (e.g., creating an opportunity for the participant 204 to interact in the simulated world 202 with a virtual chattel such as a horse, where the virtual horse has a simulated value in the simulated world 202). Operation 732 shows creating an opportunity for a player to interact with a real-world depository item with a real-world value (e.g., creating an opportunity for the participant 204 to interact with a virtual chattel such as a horse, where the virtual horse has a simulated value in the simulated world 202). Operation 734 illustrates creating an opportunity for a player to interact with a real-world depository item with a virtual value in the imaginary environment (e.g., creating an opportunity for the participant 204 to interact with a real-world chattel such as a horse, where the real-world horse has a simulated value in the simulated world 202).

Operation 738 shows creating an opportunity for a delivery of a real-world depository item by the grantor to the depository (e.g., creating an opportunity for a delivery of a real-word property deed by the participant 204 to a real-world escrow agent). Operation 740 depicts creating an opportunity for a delivery of a virtual depository item by the grantor to the depository (e.g., creating an opportunity for a delivery in the simulated world 202 of a virtual property deed by the participant 204 to a virtual escrow agent). Operation 742 illustrates creating an opportunity for a deposit of the at least one depository item by the grantor with the depository, wherein the at least one depository item includes evidence of a grantor performance of a condition and/or a grantor happening of an event (e.g., creating an opportunity for a deposit by the participant 204 in the simulated world 202 of an affidavit attesting to the performance of a condition, such as a payment, or of a letter attesting to the happening of an event, such as an approval of a loan). Operation 744 shows creating an opportunity for a performance of a real-world condition. Operation 746 depicts creating an opportunity for a performance of a virtual condition (e.g., creating an opportunity for a painting of a house in the simulated world 202 by the participant 204). Operation 748 illustrates creating an opportunity for a non-performance of a real-world condition (e.g., creating an opportunity for a non-payment of a real-world loan by the participant 204).

Operation 750 shows creating an opportunity for a non-performance of a virtual condition (e.g., creating an opportunity for a virtual loan in the simulated world 202 by the participant 204). Operation 752 shows creating an opportunity for a happening of a real-world event (e.g., creating an opportunity for an approval of a real-world loan for the participant 204). Operation 754 depicts creating an opportunity for a happening of a virtual event (e.g., creating an opportunity for an approval of a virtual loan in the simulated world 202 for the participant 204). Operation 756 illustrates creating an opportunity for a non-happening of a real-world event (e.g., creating an opportunity for a non-approval of a real-world loan for the participant 204). Operation 758 shows creating an opportunity for a non-happening of a virtual event (e.g., creating an opportunity for a non-approval of a virtual loan in the simulated world 202 for the participant 204). Operation 760 depicts creating an opportunity for the performance of the condition and/or the happening of the event within a pre-specified time frame to obligate the delivery of the at least one depository item by the depository to the grantee (e.g., creating an opportunity for making a real-world payment within a pre-specified period of one month to obligate the delivery of a virtual property deed in the simulated world 202 to the participant 204).

Operation 762 illustrates creating an opportunity for the performance of the condition and/or the happening of the event outside a pre-specified time frame to obligate the return of the at least one depository item by the depository to the grantor (e.g., creating an opportunity for making a real-world payment by the participant 204 outside a pre-specified period of one month, obligating an escrow agent to return a virtual property deed in the simulated world 202 to a prospective seller). Operation 764 depicts creating an opportunity for a delivery of a real-world depository item by the depository to the grantee (e.g., creating an opportunity for a delivery of a real-world chattel by an escrow agent to the buyer participant 204). Operation 766 depicts creating an opportunity for a delivery of a virtual depository item by the depository to the grantee (e.g., creating an opportunity for a delivery of a virtual chattel in the simulated world 202 by an escrow agent to the buyer participant 204). Operation 768 shows creating an opportunity for a delivery of a notification from the depository to the grantee of a receipt by the depository of the at least one depository item, wherein the at least one depository item includes evidence of a grantor performance of a condition and/or a grantor happening of an event (e.g., creating an opportunity for a delivery of evidence of a making of a virtual payment in the simulated world 202 by the participant 204). Operation 770 illustrates creating an opportunity for a return of a real-world depository item by the depository to the grantor (e.g., creating an opportunity for a return of a real-world deed of property by an escrow agent to a grantor participant 204). Operation 772 illustrates creating an opportunity for a return of a virtual depository item by the depository to the grantor (e.g., creating an opportunity for a return in the simulated world 202 of a virtual deed of property by an escrow agent to a grantor participant 204).

Operation 774 shows creating an opportunity for the performance of the condition and/or the happening of the event to include a delivery of a barter item by the grantee to the grantor and/or to a real-world third-party receiver as the performance of the condition and/or the happening of the event (e.g., creating an opportunity for the performance of the condition and/or the happening of the event to include a delivery of one or more goods and/or services by a participant 204 to a real-world person and/or third party (either the escrow agent or someone else)). Operation 776 illustrates creating an opportunity for the performance of the condition and/or the happening of the event to include a delivery of a barter item by the grantee to the grantor and/or to a simulated-world third-party receiver as the performance of the condition and/or the happening of the event, wherein the simulated-world third-party receiver represents a real-world receiver player (e.g., creating an opportunity for the performance of the condition and/or the happening of the event to include a delivery of one or more goods and/or services to a person or a third party in the simulated world 202 (corresponding to either the escrow agent or someone else in the real-world)). Operation 778 depicts creating an opportunity for the performance of the condition and/or the happening of the event to include a delivery of a barter item by the grantee to the grantor and/or to a simulated-world third-party receiver as the performance of the condition and/or the happening of the event, wherein the simulated-world third-party receiver represents no real-world receiver player (e.g., creating an opportunity for the performance of the condition and/or the happening of the event to include a delivery of one or more goods and/or services to a person or a third party in the simulated world 202 (corresponding to no-one in the real-world)).

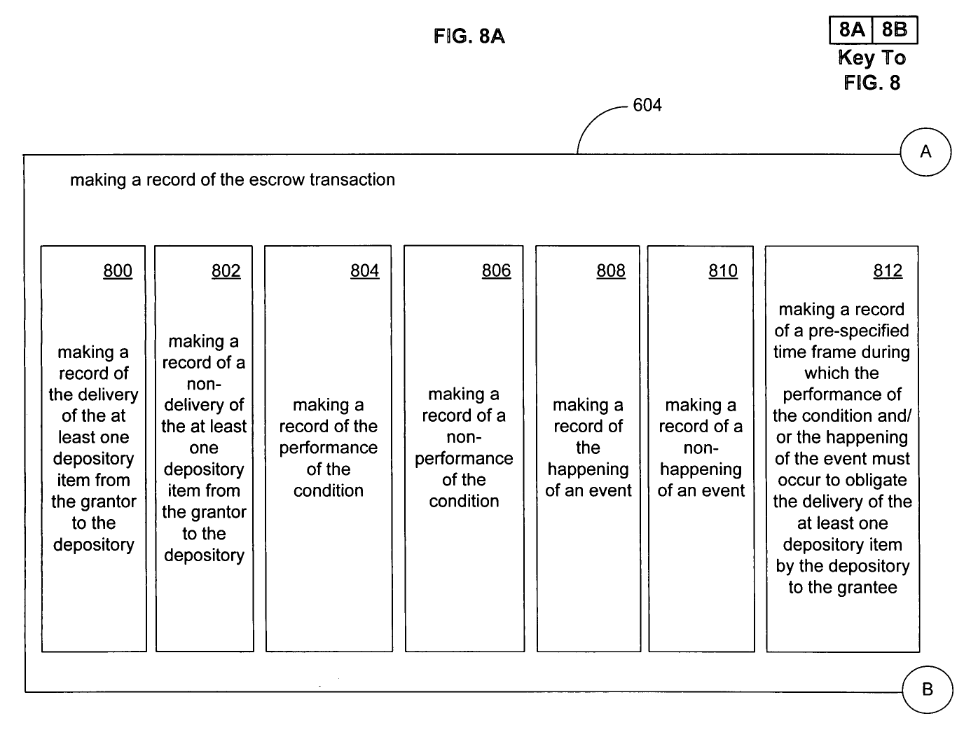

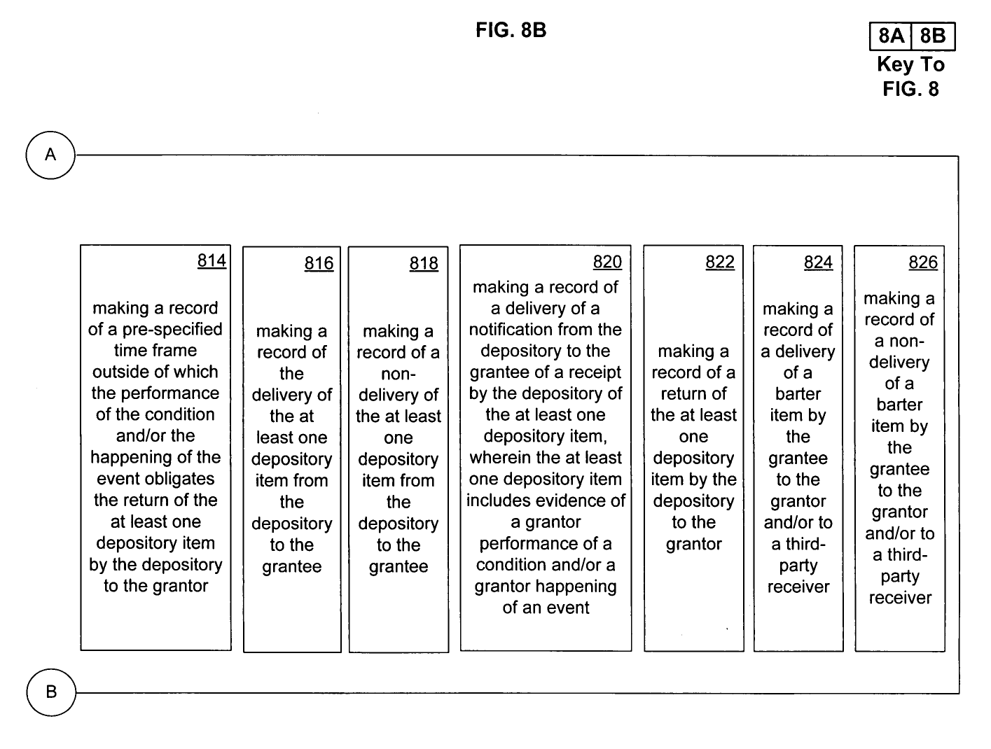

FIG. 8 shows several alternative implementations of the high-level logic flowchart of FIG. 6. Depicted is that operation 604 making a record of the escrow transaction may include one or more of the following operations: 800, 802, 804, 806, 808, 810, 812, 814, 816, 818, 820, 822, 824, and/or 826. Operation 800 shows making a record of the delivery of the at least one depository item from the grantor to the depository (e.g., making a record, using the memory device 212, of the delivery of a property deed from a seller to an escrow agent participant 204). Operation 802 illustrates making a record of a non-delivery of the at least one depository item from the grantor to the depository (e.g., making a record, using the memory device 212, of a non-delivery of a property deed from a seller to an escrow agent participant 204). Operation 804 depicts making a record of the performance of the condition (e.g., making a record, using the memory device 212, of a record of a payment by the participant 204). Operation 806 illustrates making a record of a non-performance of the condition (e.g., making a record, using the memory device 212, of a record of a failure to take a payment to the participant 204). Operation 808 depicts making a record of the happening of an event (e.g., making a record, using the memory device 212, of an approval of a loan to the participant 204). Operation 810 depicts making a record of a non-happening of an event (e.g., making a record, using the memory device 212, of a non-approval of a loan to a prospective buyer of property from the participant 204). Operation 812 illustrates making a record of a pre-specified time frame during which the performance of the condition and/or the happening of the event must occur to obligate the delivery of the at least one depository item by the depository to the grantee (e.g., making a record, using the memory device 212, of a pre-specified three-month period during which a making of a payment by the participant 204 must occur to obligate the delivery of a property deed to the participant 204).

Operation 814 illustrates making a record of a pre-specified time frame outside of which the performance of the condition and/or the happening of the event obligates the return of the at least one depository item by the depository to the grantor (e.g., making a record, using the memory device 212, of a two-week period outside of which a making of a payment by a prospective buyer obligates the return of a chattel to a prospective seller participant 204). Operation 816 depicts making a record of the delivery of the at least one depository item from the depository to the grantee (e.g., making a record, using the memory device 212, of a delivery of a chattel from an escrow agent to a buyer participant 204). Operation 818 shows making a record of a non-delivery of the at least one depository item from the depository to the grantee (e.g., making a record, using the memory device 212, of a non-delivery of a property deed from an escrow agent participant 204 to a buyer). Operation 820 shows making a record of a delivery of a notification from the depository to the grantee of a receipt by the depository of the at least one depository item, wherein the at least one depository item includes evidence of a grantor performance of a condition and/or a grantor happening of an event (e.g., making a record, using the memory device 212, of a delivery of a notification by an escrow agent to a prospective seller participant 204 of receipt by the escrow agent of evidence of approval of a loan to a prospective buyer). Operation 822 depicts making a record of a return of the at least one depository item by the depository to the grantor (e.g., making a record, using the memory device 212, of a return of a chattel participant 204 to a prospective seller by the escrow agent). Operation 824 illustrates making a record of a delivery of a barter item by the grantee to the grantor and/or to a third-party receiver (e.g., making a record, using the memory device 212, of a delivery of one or more goods and/or services by a participant 204 to a person and/or third party (either the escrow agent or someone else)). Operation 826 shows making a record of a non-delivery of a barter item by the grantee to the grantor and/or to a third-party receiver (e.g., making a record, using the memory device 212, of a non-delivery of one or more goods and/or services by a participant 204 to a person and/or third party (either the escrow agent or someone else)).

Those having skill in the art will recognize that the state of the art has progressed to the point where there is little distinction left between hardware and software implementations of aspects of systems; the use of hardware or software is generally (but not always, in that in certain contexts the choice between hardware and software can become significant) a design choice representing cost vs. efficiency tradeoffs. Those having skill in the art will appreciate that there are various vehicles by which processes and/or systems and/or other technologies described herein can be effected (e.g., hardware, software, and/or firmware), and that the preferred vehicle will vary with the context in which the processes and/or systems and/or other technologies are deployed. For example, if an implementer determines that speed and accuracy are paramount, the implementer may opt for a mainly hardware and/or firmware vehicle; alternatively, if flexibility is paramount, the implementer may opt for a mainly software implementation; or, yet again alternatively, the implementer may opt for some combination of hardware, software, and/or firmware. Hence, there are several possible vehicles by which the processes and/or devices and/or other technologies described herein may be effected, none of which is inherently superior to the other in that any vehicle to be utilized is a choice dependent upon the context in which the vehicle will be deployed and the specific concerns (e.g., speed, flexibility, or predictability) of the implementer, any of which may vary. Those skilled in the art will recognize that optical aspects of implementations will typically employ optically-oriented hardware, software, and or firmware.

The foregoing detailed description has set forth various embodiments of the devices and/or processes via the use of block diagrams, flowcharts, and/or examples. Insofar as such block diagrams, flowcharts, and/or examples contain one or more functions and/or operations, it will be understood by those within the art that each function and/or operation within such block diagrams, flowcharts, or examples can be implemented, individually and/or collectively, by a wide range of hardware, software, firmware, or virtually any combination thereof. In one embodiment, several portions of the subject matter described herein may be implemented via Application Specific Integrated Circuits (ASICs), Field Programmable Gate Arrays (FPGAs), digital signal processors (DSPs), or other integrated formats. However, those skilled in the art will recognize that some aspects of the embodiments disclosed herein, in whole or in part, can be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skill in the art in light of this disclosure. In addition, those skilled in the art will appreciate that the mechanisms of the subject matter described herein are capable of being distributed as a program product in a variety of forms, and that an illustrative embodiment of the subject matter described herein applies equally regardless of the particular type of signal bearing media used to actually carry out the distribution. Examples of a signal bearing media include, but are not limited to, the following: recordable type media such as floppy disks, hard disk drives, CD ROMs, digital tape, and computer memory; and transmission type media such as digital and analog communication links using TDM or IP based communication links (e.g., packet links).

In a general sense, those skilled in the art will recognize that the various aspects described herein which can be implemented, individually and/or collectively, by a wide range of hardware, software, firmware, or any combination thereof can be viewed as being composed of various types of “electrical circuitry.” Consequently, as used herein “electrical circuitry” includes, but is not limited to, electrical circuitry having at least one discrete electrical circuit, electrical circuitry having at least one integrated circuit, electrical circuitry having at least one application specific integrated circuit, electrical circuitry forming a general purpose computing device configured by a computer program (e.g., a general purpose computer configured by a computer program which at least partially carries out processes and/or devices described herein, or a microprocessor configured by a computer program which at least partially carries out processes and/or devices described herein), electrical circuitry forming a memory device (e.g., forms of random access memory), and/or electrical circuitry forming a communications device (e.g., a modem, communications switch, or optical-electrical equipment).

Those skilled in the art will recognize that it is common within the art to describe devices and/or processes in the fashion set forth herein, and thereafter use engineering practices to integrate such described devices and/or processes into image processing systems. That is, at least a portion of the devices and/or processes described herein can be integrated into an image processing system via a reasonable amount of experimentation. Those having skill in the art will recognize that a typical image processing system generally includes one or more of a system unit housing, a video display device, a memory such as volatile and non-volatile memory, processors such as microprocessors and digital signal processors, computational entities such as operating systems, drivers, and applications programs, one or more interaction devices, such as a touch pad or screen, control systems including feedback loops and control motors (e.g., feedback for sensing lens position and/or velocity; control motors for moving/distorting lenses to give desired focuses. A typical image processing system may be implemented utilizing any suitable commercially available components, such as those typically found in digital still systems and/or digital motion systems.

Those skilled in the art will recognize that it is common within the art to describe devices and/or processes in the fashion set forth herein, and thereafter use engineering practices to integrate such described devices and/or processes into data processing systems. That is, at least a portion of the devices and/or processes described herein can be integrated into a data processing system via a reasonable amount of experimentation. Those having skill in the art will recognize that a typical data processing system generally includes one or more of a system unit housing, a video display device, a memory such as volatile and non-volatile memory, processors such as microprocessors and digital signal processors, computational entities such as operating systems, drivers, graphical user interfaces, and applications programs, one or more interaction devices, such as a touch pad or screen, and/or control systems including feedback loops and control motors (e.g., feedback for sensing position and/or velocity; control motors for moving and/or adjusting components and/or quantities). A typical data processing system may be implemented utilizing any suitable commercially available components, such as those typically found in data computing/communication and/or network computing/communication systems.

All of the above U.S. patents, U.S. patent application publications, U.S. patent applications, foreign patents, foreign patent applications and non-patent publications referred to in this specification and/or listed in any Application Data Sheet, are incorporated herein by reference, in their entireties.

The herein described subject matter sometimes illustrates different components contained within, or connected with, different other components. It is to be understood that such depicted architectures are merely exemplary, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include but are not limited to physically mateable and/or physically interacting components and/or wirelessly interactable and/or wirelessly interacting components and/or logically interacting and/or logically interactable components.

While particular aspects of the present subject matter described herein have been shown and described, it will be apparent to those skilled in the art that, based upon the teachings herein, changes and modifications may be made without departing from the subject matter described herein and its broader aspects and, therefore, the appended claims are to encompass within their scope all such changes and modifications as are within the true spirit and scope of this subject matter described herein. Furthermore, it is to be understood that the invention is defined by the appended claims. It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to inventions containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim. recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.).

1. (canceled)

2. (canceled)

3. (canceled)

4. (canceled)

5. (canceled)

6. (canceled)

7. (canceled)

8. (canceled)

9. (canceled)

10. (canceled)

11. (canceled)

12. (canceled)

13. (canceled)

14. (canceled)

15. (canceled)

16. (canceled)

17. (canceled)

18. (canceled)

19. (canceled)

20. (canceled)

21. (canceled)

22. (canceled)

23. (canceled)

24. (canceled)

25. (canceled)

26. (canceled)

27. (canceled)

28. (canceled)

29. (canceled)

30. (canceled)

31. (canceled)

32. (canceled)

33. (canceled)

34. (canceled)

35. (canceled)

36. (canceled)

37. (canceled)

38. (canceled)

39. (canceled)

40. (canceled)

41. (canceled)

42. (canceled)

43. (canceled)

44. (canceled)

45. (canceled)

46. (canceled)

47. (canceled)

48. (canceled)

49. (canceled)

50. (canceled)

51. (canceled)

52. (canceled)

53. A method of conducting virtual world transactions, comprising:
providing an imaginary environment where a player is enabled to choose a destination and/or activity and/or event;
creating an opportunity in the imaginary environment for the player to participate in an escrow transaction, wherein the escrow transaction involves a delivery of at least one depository item by a grantor to a depository prior to a performance of a condition and/or a happening of an event and a delivery of the at least one depository item by the depository to a grantee upon the performance of the condition and/or the happening of the event; and
making a record of the escrow transaction.

54. (canceled)

55. (canceled)

56. (canceled)

57. (canceled)

58. (canceled)

59. (canceled)

60. (canceled)

61. (canceled)

62. (canceled)

63. (canceled)

64. (canceled)

65. (canceled)

66. (canceled)

67. (canceled)

68. (canceled)

69. (canceled)

70. (canceled)

71. (canceled)

72. (canceled)

73. (canceled)

74. (canceled)

75. (canceled)

76. (canceled)

77. (canceled)

78. (canceled)

79. (canceled)

80. (canceled)

81. (canceled)

82. (canceled)

83. (canceled)

84. (canceled)

85. (canceled)

86. (canceled)

87. (canceled)

88. (canceled)

89. (canceled)

90. (canceled)

91. (canceled)

92. (canceled)

93. (canceled)

94. (canceled)

95. (canceled)

96. (canceled)

97. (canceled)

98. (canceled)

99. (canceled)

100. (canceled)

101. (canceled)

102. (canceled)

103. (canceled)

104. (canceled)

105. (canceled)

106. (canceled)

107. A system related to conducting virtual world transactions, the system comprising:
circuitry for providing an imaginary environment where a player is enabled to choose a destination and/or activity and/or event;
circuitry for creating an opportunity in the imaginary environment for the player to participate in an escrow transaction, wherein the escrow transaction involves a delivery of at least one depository item by a grantor to a depository prior to a performance of a condition and/or a happening of an event and a delivery of the at least one depository item by the depository to a grantee upon the performance of the condition and/or the happening of the event; and
circuitry for making a record of the escrow transaction.

108. A system comprising:
means for providing an imaginary environment where a player is enabled to choose a destination and/or activity and/or event means for creating an opportunity in the imaginary environment for the player to participate in an escrow transaction, wherein the escrow transaction involves a delivery of at least one depository item by a grantor to a depository prior to a performance of a condition and/or a happening of an event and a delivery of the at least one depository item by the depository to a grantee upon the performance of the condition and/or the happening of the event; and
means for making a record of the escrow transaction.

109. A program product, comprising:
a signal bearing medium bearing
one or more instructions for providing an imaginary environment where a player is enabled to choose a destination and/or activity and/or event,
one or more instructions for creating an opportunity in the imaginary environment for the player to participate in an escrow transaction, wherein the escrow transaction involves a delivery of at least one depository item by a grantor to a depository prior to a performance of a condition and/or a happening of an event and a delivery of the at least one depository item by the depository to a grantee upon the performance of the condition and/or the happening of the event, and
one or more instructions for making a record of the escrow transaction.

110. (canceled)

111. (canceled)

112. (canceled)

113. The program product of claim 109, wherein the one or more instructions for creating an opportunity in the imaginary environment for the player to participate in an escrow transaction, wherein the escrow transaction involves a delivery of at least one depository item by a grantor to a depository prior to a performance of a condition and/or a happening of an event and a delivery of the at least one depository item by the depository to a grantee upon the performance of the condition and/or the happening of the event, further comprises:
one or more instructions for creating an opportunity for a player to participate through one or more agents in the imaginary environment, wherein the one or more agents in the imaginary world represent respective real-world agents.

114. (canceled)

115. The program product of claim 109, wherein the one or more instructions for creating an opportunity in the imaginary environment for the player to participate in an escrow transaction, wherein the escrow transaction involves a delivery of at least one depository item by a grantor to a depository prior to a performance of a condition and/or a happening of an event and a delivery of the at least one depository item by the depository to a grantee upon the performance of the condition and/or the happening of the event, further comprises:
one or more instructions for creating an opportunity for a grantor player to participate through a grantor character in the imaginary environment.

116. The program product of claim 109, wherein the one or more instructions for creating an opportunity in the imaginary environment for the player to participate in an escrow transaction, wherein the escrow transaction involves a delivery of at least one depository item by a grantor to a depository prior to a performance of a condition and/or a happening of an event and a delivery of the at least one depository item by the depository to a grantee upon the performance of the condition and/or the happening of the event, further comprises:
one or more instructions for creating an opportunity for a depository player to participate through a depository character in the imaginary environment.

117. (canceled)

118. The program product of claim 109, wherein the one or more instructions for creating an opportunity in the imaginary environment for the player to participate in an escrow transaction, wherein the escrow transaction involves a delivery of at least one depository item by a grantor to a depository prior to a performance of a condition and/or a happening of an event and a delivery of the at least one depository item by the depository to a grantee upon the performance of the condition and/or the happening of the event, further comprises:
one or more instructions for creating an opportunity for a grantee player to participate through a grantee character in the imaginary environment.

119. The program product of claim 109, wherein the one or more instructions for creating an opportunity in the imaginary environment for the player to participate in an escrow transaction, wherein the escrow transaction involves a delivery of at least one depository item by a grantor to a depository prior to a performance of a condition and/or a happening of an event and a delivery of the at least one depository item by the depository to a grantee upon the performance of the condition and/or the happening of the event, further comprises:
one or more instructions for creating an opportunity for a player to participate in the escrow transaction, wherein the escrow transaction involves a performance of a condition with an associated real-world value.

120. The program product of claim 109, wherein the one or more instructions for creating an opportunity in the imaginary environment for the player to participate in an escrow transaction, wherein the escrow transaction involves a delivery of at least one depository item by a grantor to a depository prior to a performance of a condition and/or a happening of an event and a delivery of the at least one depository item by the depository to a grantee upon the performance of the condition and/or the happening of the event, further comprises:
one or more instructions for creating an opportunity for a player to participate in the escrow transaction, wherein the escrow transaction involves a performance of a condition with an associated virtual value.

121. The program product of claim 109, wherein the one or more instructions for creating an opportunity in the imaginary environment for the player to participate in an escrow transaction, wherein the escrow transaction involves a delivery of at least one depository item by a grantor to a depository prior to a performance of a condition and/or a happening of an event and a delivery of the at least one depository item by the depository to a grantee upon the performance of the condition and/or the happening of the event, further comprises:
one or more instructions for creating an opportunity for a player to participate in the escrow transaction, wherein the escrow transaction involves a happening of an event with an associated real-world value.

122. The program product of claim 109, wherein the one or more instructions for creating an opportunity in the imaginary environment for the player to participate in an escrow transaction, wherein the escrow transaction involves a delivery of at least one depository item by a grantor to a depository prior to a performance of a condition and/or a happening of an event and a delivery of the at least one depository item by the depository to a grantee upon the performance of the condition and/or the happening of the event, further comprises:
one or more instructions for creating an opportunity for a player to participate in the escrow transaction, wherein the escrow transaction involves a happening of an event with an associated virtual value.

123. (canceled)

124. (canceled)

125. (canceled)

126. The program product of claim 109, wherein the one or more instructions for creating an opportunity in the imaginary environment for the player to participate in an escrow transaction, wherein the escrow transaction involves a delivery of at least one depository item by a grantor to a depository prior to a performance of a condition and/or a happening of an event and a delivery of the at least one depository item by the depository to a grantee upon the performance of the condition and/or the happening of the event, further comprises:
one or more instructions for creating an opportunity for a player to interact with a virtual depository item with a real-world value.

127. The program product of claim 109, wherein the one or more instructions for creating an opportunity in the imaginary environment for the player to participate in an escrow transaction, wherein the escrow transaction involves a delivery of at least one depository item by a grantor to a depository prior to a performance of a condition and/or a happening of an event and a delivery of the at least one depository item by the depository to a grantee upon the performance of the condition and/or the happening of the event, further comprises:
one or more instructions for creating an opportunity for a player to interact with a virtual depository item with a virtual value in the imaginary environment.

128. The program product of claim 109, wherein the one or more instructions for creating an opportunity in the imaginary environment for the player to participate in an escrow transaction, wherein the escrow transaction involves a delivery of at least one depository item by a grantor to a depository prior to a performance of a condition and/or a happening of an event and a delivery of the at least one depository item by the depository to a grantee upon the performance of the condition and/or the happening of the event, further comprises:
one or more instructions for creating an opportunity for a player to interact with a real-world depository item with a real-world value.

129. (canceled)

130. The program product of claim 109, wherein the one or more instructions for creating an opportunity in the imaginary environment for the player to participate in an escrow transaction, wherein the escrow transaction involves a delivery of at least one depository item by a grantor to a depository prior to a performance of a condition and/or a happening of an event and a delivery of the at least one depository item by the depository to a grantee upon the performance of the condition and/or the happening of the event, further comprises:
one or more instructions for creating an opportunity for a delivery of a real-world depository item by the grantor to the depository.

131. The program product of claim 109, wherein the one or more instructions for creating an opportunity in the imaginary environment for the player to participate in an escrow transaction, wherein the escrow transaction involves a delivery of at least one depository item by a grantor to a depository prior to a performance of a condition and/or a happening of an event and a delivery of the at least one depository item by the depository to a grantee upon the performance of the condition and/or the happening of the event, further comprises:
one or more instructions for creating an opportunity for a delivery of a virtual depository item by the grantor to the depository.

132. The program product of claim 109, wherein the one or more instructions for creating an opportunity in the imaginary environment for the player to participate in an escrow transaction, wherein the escrow transaction involves a delivery of at least one depository item by a grantor to a depository prior to a performance of a condition and/or a happening of an event and a delivery of the at least one depository item by the depository to a grantee upon the performance of the condition and/or the happening of the event, further comprises:
one or more instructions for creating an opportunity for a deposit of the at least one depository item by the grantor with the depository, wherein the at least one depository item includes evidence of a grantor performance of a condition and/or a grantor happening of an event.

133. The program product of claim 109, wherein the one or more instructions for creating an opportunity in the imaginary environment for the player to participate in an escrow transaction, wherein the escrow transaction involves a delivery of at least one depository item by a grantor to a depository prior to a performance of a condition and/or a happening of an event and a delivery of the at least one depository item by the depository to a grantee upon the performance of the condition and/or the happening of the event, further comprises:
one or more instructions for creating an opportunity for a performance of a real-world condition.

134. The program product of claim 109, wherein the one or more instructions for creating an opportunity in the imaginary environment for the player to participate in an escrow transaction, wherein the escrow transaction involves a delivery of at least one depository item by a grantor to a depository prior to a performance of a condition and/or a happening of an event and a delivery of the at least one depository item by the depository to a grantee upon the performance of the condition and/or the happening of the event, further comprises:
one or more instructions for creating an opportunity for a performance of a virtual condition.

135. The program product of claim 109, wherein the one or more instructions for creating an opportunity in the imaginary environment for the player to participate in an escrow transaction, wherein the escrow transaction involves a delivery of at least one depository item by a grantor to a depository prior to a performance of a condition and/or a happening of an event and a delivery of the at least one depository item by the depository to a grantee upon the performance of the condition and/or the happening of the event, further comprises:
one or more instructions for creating an opportunity for a non-performance of a real-world condition.

136. The program product of claim 109, wherein the one or more instructions for creating an opportunity in the imaginary environment for the player to participate in an escrow transaction, wherein the escrow transaction involves a delivery of at least one depository item by a grantor to a depository prior to a performance of a condition and/or a happening of an event and a delivery of the at least one depository item by the depository to a grantee upon the performance of the condition and/or the happening of the event, further comprises:
one or more instructions for creating an opportunity for a non-performance of a virtual condition.

137. The program product of claim 109, wherein the one or more instructions for creating an opportunity in the imaginary environment for the player to participate in an escrow transaction, wherein the escrow transaction involves a delivery of at least one depository item by a grantor to a depository prior to a performance of a condition and/or a happening of an event and a delivery of the at least one depository item by the depository to a grantee upon the performance of the condition and/or the happening of the event, further comprises:
one or more instructions for creating an opportunity for a happening of a real-world event.

138. The program product of claim 109, wherein the one or more instructions for creating an opportunity in the imaginary environment for the player to participate in an escrow transaction, wherein the escrow transaction involves a delivery of at least one depository item by a grantor to a depository prior to a performance of a condition and/or a happening of an event and a delivery of the at least one depository item by the depository to a grantee upon the performance of the condition and/or the happening of the event, further comprises:
one or more instructions for creating an opportunity for a happening of a virtual event.

139. The program product of claim 109, wherein the one or more instructions for creating an opportunity in the imaginary environment for the player to participate in an escrow transaction, wherein the escrow transaction involves a delivery of at least one depository item by a grantor to a depository prior to a performance of a condition and/or a happening of an event and a delivery of the at least one depository item by the depository to a grantee upon the performance of the condition and/or the happening of the event, further comprises:
one or more instructions for creating an opportunity for a non-happening of a real-world event.

140. The program product of claim 109, wherein the one or more instructions for creating an opportunity in the imaginary environment for the player to participate in an escrow transaction, wherein the escrow transaction involves a delivery of at least one depository item by a grantor to a depository prior to a performance of a condition and/or a happening of an event and a delivery of the at least one depository item by the depository to a grantee upon the performance of the condition and/or the happening of the event, further comprises:
one or more instructions for creating an opportunity for a non-happening of a virtual event.

141. The program product of claim 109, wherein the one or more instructions for creating an opportunity in the imaginary environment for the player to participate in an escrow transaction, wherein the escrow transaction involves a delivery of at least one depository item by a grantor to a depository prior to a performance of a condition and/or a happening of an event and a delivery of the at least one depository item by the depository to a grantee upon the performance of the condition and/or the happening of the event, further comprises:
one or more instructions for creating an opportunity for the performance of the condition and/or the happening of the event within a pre-specified time frame to obligate the delivery of the at least one depository item by the depository to the grantee.

142. The program product of claim 109, wherein the one or more instructions for creating an opportunity in the imaginary environment for the player to participate in an escrow transaction, wherein the escrow transaction involves a delivery of at least one depository item by a grantor to a depository prior to a performance of a condition and/or a happening of an event and a delivery of the at least one depository item by the depository to a grantee upon the performance of the condition and/or the happening of the event, further comprises:
one or more instructions for creating an opportunity for the performance of the condition and/or the happening of the event outside a pre-specified time frame to obligate the return of the at least one depository item by the depository to the grantor.

143. The program product of claim 109, wherein the one or more instructions for creating an opportunity in the imaginary environment for the player to participate in an escrow transaction, wherein the escrow transaction involves a delivery of at least one depository item by a grantor to a depository prior to a performance of a condition and/or a happening of an event and a delivery of the at least one depository item by the depository to a grantee upon the performance of the condition and/or the happening of the event, further comprises:
one or more instructions for creating an opportunity for a delivery of a real-world depository item by the depository to the grantee.

144. The program product of claim 109, wherein the one or more instructions for creating an opportunity in the imaginary environment for the player to participate in an escrow transaction, wherein the escrow transaction involves a delivery of at least one depository item by a grantor to a depository prior to a performance of a condition and/or a happening of an event and a delivery of the at least one depository item by the depository to a grantee upon the performance of the condition and/or the happening of the event, further comprises:
one or more instructions for creating an opportunity for a delivery of a virtual depository item by the depository to the grantee.

145. The program product of claim 109, wherein the one or more instructions for creating an opportunity in the imaginary environment for the player to participate in an escrow transaction, wherein the escrow transaction involves a delivery of at least one depository item by a grantor to a depository prior to a performance of a condition and/or a happening of an event and a delivery of the at least one depository item by the depository to a grantee upon the performance of the condition and/or the happening of the event, further comprises:
one or more instructions for creating an opportunity for a delivery of a notification from the depository to the grantee of a receipt by the depository of the at least one depository item, wherein the at least one depository item includes evidence of a grantor performance of a condition and/or a grantor happening of an event.

146. The program product of claim 109, wherein the one or more instructions for creating an opportunity in the imaginary environment for the player to participate in an escrow transaction, wherein the escrow transaction involves a delivery of at least one depository item by a grantor to a depository prior to a performance of a condition and/or a happening of an event and a delivery of the at least one depository item by the depository to a grantee upon the performance of the condition and/or the happening of the event, further comprises:
one or more instructions for creating an opportunity for a return of a real-world depository item by the depository to the grantor.

147. The program product of claim 109, wherein the one or more instructions for creating an opportunity in the imaginary environment for the player to participate in an escrow transaction, wherein the escrow transaction involves a delivery of at least one depository item by a grantor to a depository prior to a performance of a condition and/or a happening of an event and a delivery of the at least one depository item by the depository to a grantee upon the performance of the condition and/or the happening of the event, further comprises:
one or more instructions for creating an opportunity for a return of a virtual depository item by the depository to the grantor.

148. (canceled)

149. (canceled)

150. (canceled)

151. The program product of claim 109, wherein the one or more instructions for making a record of the escrow transaction further comprises:
one or more instructions for making a record of the delivery of the at least one depository item from the grantor to the depository.

152. The program product of claim 109, wherein the one or more instructions for making a record of the escrow transaction further comprises:
one or more instructions for making a record of a non-delivery of the at least one depository item from the grantor to the depository.

153. The program product of claim 109, wherein the one or more instructions for making a record of the escrow transaction further comprises:
one or more instructions for making a record of the performance of the condition.

154. The program product of claim 109, wherein the one or more instructions for making a record of the escrow transaction further comprises:
one or more instructions for making a record of a non-performance of the condition.

155. The program product of claim 109, wherein the one or more instructions for making a record of the escrow transaction further comprises:
one or more instructions for making a record of the happening of an event.

156. (canceled)

157. The program product of claim 109, wherein the one or more instructions for making a record of the escrow transaction further comprises:
one or more instructions for making a record of a pre-specified time frame during which the performance of the condition and/or the happening of the event must occur to obligate the delivery of the at least one depository item by the depository to the grantee.

158. The program product of claim 109, wherein the one or more instructions for making a record of the escrow transaction further comprises:
one or more instructions for making a record of a pre-specified time frame outside of which the performance of the condition and/or the happening of the event obligates the return of the at least one depository item by the depository to the grantor.

159. The program product of claim 109, wherein the one or more instructions for making a record of the escrow transaction further comprises:
one or more instructions for making a record of the delivery of the at least one depository item from the depository to the grantee.

160. (canceled)

161. The program product of claim 109, wherein the one or more instructions for making a record of the escrow transaction further comprises:
one or more instructions for making a record of a delivery of a notification from the depository to the grantee of a receipt by the depository of the at least one depository item, wherein the at least one depository item includes evidence of a grantor performance of a condition and/or a grantor happening of an event.

162. The program product of claim 109, wherein the one or more instructions for making a record of the escrow transaction further comprises:
one or more instructions for making a record of a return of the at least one depository item by the depository to the grantor.

163. (canceled)

164. (canceled)
